(19) United States
(12) Patent Application Publication
(10) Pub. No.: US 2013/0033698 A1
(43) Pub. Date: Feb. 7, 2013

(54) FILM THICKNESS MEASUREMENT APPARATUS

(71) Applicant: Tadayoshi FUJIMORI, Ritto-shi (JP)

(72) Inventor: Tadayoshi FUJIMORI, Ritto-shi (JP)

(73) Assignee: Otsuka Electronics Co., Ltd., Hirakata-shi (JP)

(21) Appl. No.: 13/537,055

(22) Filed: Jun. 29, 2012

(30) Foreign Application Priority Data
Aug. 2, 2011 (JP) 2011-169368

(51) Int. Cl. G01B 11/06

(52) U.S. Cl. 356/51; 356/630; 356/632

(57) ABSTRACT

The present invention is a film thickness measurement apparatus including a light source, a first optical path, a first condenser lens, a spectrometry unit, a second optical path, a second condenser lens, and a data processing unit. The light source emits measurement light having a predetermined wavelength range. The first optical path guides to an object to be measured the measurement light. The first condenser lens condenses the measurement light. The spectrometry unit obtains a wavelength distribution characteristic of reflectance or transmittance. The second optical path guides to the spectrometry unit the light reflected by or transmitted through the object. The second condenser lens condenses light at an end of the second optical path. The data processing unit analyzes the wavelength distribution characteristic obtained in the spectrometry unit to obtain a film thickness of the object.

### BACKGROUND OF THE INVENTION

1. Field of the Invention

The present invention relates to a film thickness measurement apparatus, and more specifically to a configuration for measuring in thickness at least one film of an object having a substrate with the film deposited thereon.

2. Description of the Background Art

In recent years, a substrate structure referred to as silicon on insulator (SOI) attracts attention for complementary metal oxide semiconductor (CMOS) circuits and the like with reduced power consumption and higher speed. This SOI substrate is two silicon (Si) substrates with a SiO₂ or similar insulating layer (a BOX layer) therebetween, and it can reduce a parasitic diode, a stray capacitance, and the like caused between a PN junction formed at one Si layer and the other Si layer (or a substrate).

One such known SOI substrate production method forms an oxide film on a surface of a silicon wafer and bonds another silicon wafer thereto to sandwich the oxide film therebetween, and furthermore, polishes the silicon wafer that is provided with a circuit device to obtain a predetermined thickness.

Using a polishing step to control a silicon wafer in thickness requires monitoring a film in thickness continuously. The polishing step is performed with a film measured in thickness with apparatuses in methods using a Fourier transform infrared spectrometer (FTIR), as disclosed in Japanese Patent Laying-Open Nos. 2009-270939, 05-306910 and 05-308096.

Furthermore, Japanese Patent Laying-Open No. 2003-114107 discloses a film thickness measurement apparatus of an optical interference system using infrared light as measurement light.

Furthermore, Japanese Patent Laying-Open No. 2005-19920 discloses a method using a reflection spectrum measured with a dispersion type multi-channel spectroscope.

Furthermore, Japanese Patent Laying-Open No. 2002-228420 discloses a method, as follows: A thin silicon film has a surface exposed to an infrared ray having a wavelength equal to or larger than 0.9 μm. The thin silicon film's front and back surfaces reflect the infrared ray and their respective reflections interfere with each other, and this interference is utilized to measure the thin silicon film in thickness.

Furthermore, Japanese Patent Laying-Open No. 10-125634 discloses a method, as follows: An infrared light source outputs an infrared ray which is in turn transmitted through a polisher to expose an object to be polished to the infrared ray. The object reflects light which is in turn detected to therefrom measure a film in thickness.

However, the measurement apparatus disclosed in Japanese Patent Laying-Open No. 2009-270939 can only measure a limited wavelength of light and cannot measure objects having films large in thickness. Furthermore, Japanese Patent Laying-Open No. 2009-270939 describes an optical configuration utilizing interference of light that is attributed to an optical path difference between reflected light incident on a condenser lens and that reflected by the condenser lens at the exit surface. It is thus limited in distance to an object to be measured (i.e., work distance), depth of focus, and the like.

Japanese Patent Laying-Open Nos. 05-306910 and 05-308096 only disclose methods to measure a value of a film in thickness relative to a sample serving as a reference and the methods cannot be used to measure the film's thickness in absolute value.

Furthermore, Japanese Patent Laying-Open No. 2003-114107 discloses a measurement apparatus requiring an analysis method of high precision and measurement data of high precision and used to measure a color filter used in a liquid crystal display device.

Furthermore, Japanese Patent Laying-Open No. 2005-19920 discloses a measurement method in which it is assumed that for example an index of refraction is a fixed value independent of wavelength and an autoregressive model is used to provide period estimation. In reality, however, an index of refraction is wavelength-dependent, and the method cannot eliminate an error attributed to wavelength dependence.

Furthermore, Japanese Patent Laying-Open No. 2002-228420 discloses a method requiring that a sample to be measured requires a through hole, and the method cannot be used to measure film in thickness nondestructively and continuously.

### SUMMARY OF INVENTION

The present invention contemplates a film thickness measurement apparatus that can measure a film of an object in thickness with high precision without depending on its distance to the object.

The present invention in one aspect provides a film thickness measurement apparatus including a light source, at least one first optical path, a first condenser lens, a spectrometry unit, at least one second optical path, a second condenser lens, and a data processing unit. The light source exposes an object to be measured to measurement light having a predetermined wavelength range, the object including a substrate and at least one layer of film on the substrate. The at least one first optical path guides to the object the measurement light emitted from the light source. The first condenser lens condenses the measurement light that exits via the first optical path at the object. The spectrometry unit obtains a wavelength distribution characteristic of one of reflectance and transmittance based on the measurement light condensed by the first condenser lens that is reflected by or transmitted through the object. The at least one second optical path guides the light that is reflected by or transmitted through the object to the spectrometry unit. The second condenser lens condenses the light that is reflected by or transmitted through the object at an end of the second optical path. The data processing unit analyzes the wavelength distribution characteristic obtained in the spectrometry unit to obtain a film thickness of the object.

The present film thickness measurement apparatus can thus measure a film of an object in thickness with higher precision without depending on its distance to the object.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 shows a schematic configuration of a film thickness measurement apparatus according to a first embodiment of the present invention.

FIG. 2A and FIG. 2B schematically illustrate a distance between a condensing optical probe according to the first embodiment of the present invention and an object to be measured.

FIG. 3A to FIG. 3C are schematic diagrams for illustrating a principle of the condensing optical probe according to the first embodiment of the present invention.

FIG. 4 shows an object OBJ in a schematic cross section by way of example to be measured with the film thickness measurement apparatus according to the first embodiment of the present invention.

FIG. 5A to FIG. 5C show a result of measuring an SOI substrate with the film thickness measurement apparatus according to the first embodiment of the present invention.

FIG. 6A and FIG. 6B show another result of measuring an SOI substrate with the film thickness measurement apparatus according to the first embodiment of the present invention.

FIG. 7A and FIG. 7B show still another result of measuring an SOI substrate with the film thickness measurement apparatus according to the first embodiment of the present invention.

FIG. 8A to FIG. 8C are diagrams for illustrating a relationship between a film thickness measurement range and a detection unit's wavelength detection range and number of detection points according to the first embodiment of the present invention.

FIG. 9 shows a result of measuring a reflectance spectrum for an SOI substrate.

FIG. 10 is a schematic diagram showing a schematic hardware configuration of a data processing unit according to the first embodiment of the present invention.

FIG. 11 is a block diagram showing a control structure to perform a film thickness calculation process related to a processing pattern according to the first embodiment of the present invention.

FIG. 12 is a flowchart of a procedure of the film thickness calculation process related to the processing pattern according to the first embodiment of the present invention.

FIG. 13A to FIG. 13D plot by way of example power spectra obtained by the film thickness measurement apparatus according to the first embodiment of the present invention.

FIG. 14 is a table showing an example of a result of measurement obtained by the film thickness measurement apparatus according to the first embodiment of the present invention.

FIG. 15 is a schematic diagram for illustrating varying a focal position of the condensing optical probe in the film thickness measurement apparatus according to the first embodiment of the present invention.

FIG. 16A and FIG. 16B show an example of a result of measurement obtained by the film thickness measurement apparatus according to the first embodiment of the present invention when the apparatus has a focal position changed.

FIG. 17 is a schematic diagram for illustrating an inclination of an object to be measured with the film thickness measurement apparatus according to the first embodiment of the present invention.

FIG. 18A and FIG. 18B show an example of a result of measurement obtained by the film thickness measurement apparatus according to the first embodiment of the present invention with an object to be measured varied in inclination.

FIG. 19 is a schematic diagram showing an example of the film thickness measurement apparatus according to the first embodiment of the present invention measuring an object through urethane.

FIG. 20A to FIG. 20D plot by way of example power spectra measured through urethane and thus obtained by the film thickness measurement apparatus according to the first embodiment of the present invention.

FIG. 21 is a table showing an example of a result of measurement obtained by the film thickness measurement apparatus according to the first embodiment of the present invention through a water screen and urethane.

FIG. 22 is a schematic diagram showing an example of the film thickness measurement apparatus according to the first embodiment of the present invention measuring an object through glass.

FIG. 23A and FIG. 23B plot by way of example power spectra measured with the film thickness measurement apparatus according to the first embodiment of the present invention with an ASE light source and an SLD light source used.

FIG. 24A and FIG. 24B are schematic diagrams for illustrating a configuration of a condensing optical probe according to a second embodiment of the present invention.

FIG. 25 is a schematic diagram for illustrating a configuration of a condensing optical probe according to a third embodiment of the present invention.

### DESCRIPTION OF THE PREFERRED EMBODIMENTS

Hereinafter reference will be made to the drawings to describe the present invention in embodiments. In the figures, identical or corresponding components are identically denoted and will not be described repeatedly in detail.

### First Embodiment

### Configuration of Apparatus

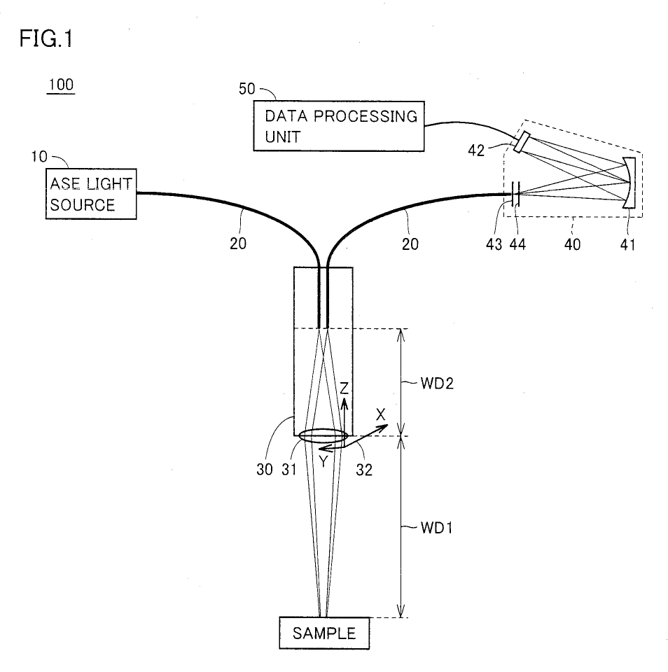

FIG. 1 schematically shows in configuration a film thickness measurement apparatus 100 according to a first embodiment of the present invention.

Film thickness measurement apparatus 100 according to the first embodiment can typically measure a single layer or each layer of a stack of layers (or a sample) in thickness. In particular, film thickness measurement apparatus 100 according to the first embodiment is suitable for measuring in thickness a film of an object including a layer relatively large in thickness (representatively, 2 μm to 2500 μm).

Specifically, film thickness measurement apparatus 100 is a spectrometric measurement apparatus. More specifically, film thickness measurement apparatus 100 exposes an object to be measured to light, which is in turn reflected by the object. The reflection of the light has a wavelength distribution characteristic (hereinafter also referred to as a “spectrum”), and therefrom, each layer of the object can be measured in thickness. Note that film thickness measurement apparatus 100 is not limited to measuring film in thickness: it can also be used to measure (absolute and relative) reflectance for each layer and analyze the layer in structure. Note that a spectrum of light reflected by an object to be measured may be replaced with that of light transmitted therethrough.

In the present specification, a substrate alone or a substrate having at least one layer of film deposited thereon is measured by way of example. More specifically, it includes a Si substrate, a glass substrate, a sapphire substrate and other similar substrates alone relatively large in thickness, a silicon on insulator (SOI) substrate and other similar substrates structured of stacked layers, and the like, by way of example. In particular, the first embodiment provides film thickness measurement apparatus 100 to be suitable for measuring in thickness a film of a ground or polished Si substrate, a film of a Si layer (or an active layer) of an SOI substrate, a film of a Si substrate in a chemical mechanical polishing (CMP) step, and the like. Furthermore, it is suitable for measuring in thickness a film, a base material and the like of polyethylene terephthalate (PET), triacetylcellulose (TAC) and the like in a film production process.

In particular, the first embodiment provides film thickness measurement apparatus 100 that measures measurement light used to measure an optical property of an object to be measured and light reflected by the object, via a Y type single-mode fiber and a condensing optical probe, to measure the optical property with higher precision and also facilitate focusing at the object.

With reference to FIG. 1, film thickness measurement apparatus 100 includes a measurement light source 10, an optical fiber 20, a condensing optical probe 30, a spectrometry unit 40, and a data processing unit 50.

Measurement light source 10 is a light source which generates measurement light used in measuring an optical property of an object to be measured, and is implemented as an amplified spontaneous emission (ASE) light source. Note that when a film of a particular thickness is measured, measurement light source 10 may be a super luminescent diode (SLD) light source. Measurement light source 10 generates measurement light including a wavelength of a range to measure an optical property for the object to be measured (i.e., 1540 nm to 1610 nm). In particular, while it is possible that film thickness measurement apparatus 100 according to the first embodiment may be employed with a halogen light source, the apparatus will require a light source of a powerful quantity of light, as the apparatus employs optical fiber 20 of a Y type single-mode fiber. Furthermore, while the apparatus can utilize an SLD light source used for an optical displacement gauge disclosed in Japanese Patent Laying-Open No. 2009-270939, in the present measurement method (of a spectral interference system) the SLD light source's coherence results in a pseudo interference other than a spectral interference that should be measured, often confirmed as the fiber is bent or at a portion connected to spectrometry unit 40 and/or the like, and the SLD light source is thus unsuitable for general-purpose film thickness measurement (i.e., cases other than measuring a particular thickness).

Optical fiber 20 is Y type fiber having two single-mode fibers having their respective optical axes that are closer to the object in parallel directions, respectively (i.e., Y type single-mode fiber). Optical fiber 20 is formed of single-mode fiber having a core diameter of 9 μm, an effective wavelength range from 1460 nm to 1620 nm (a CL band for optical communications), and a transmission loss of 0.5 dB/km or less (for a wavelength of 1550 nm). Accordingly, optical fiber 20 matches the wavelength range of spectrometry unit 40 of film thickness measurement apparatus 100, and also matches the wavelength range of measurement light source 10 used. Note that optical fiber 20 is not limited to single-mode fiber, and may be multimode fiber. Furthermore, two bundles each of a plurality of single-mode fibers may be used to form the Y type fiber.

When an object to be measured is directly exposed to the light that exits optical fiber 20, reducing a work distance WD from an end of optical fiber 20 to the object (to about 10 mm or less) allows film to be measured in thickness. However, the light output through optical fiber 20 having the core diameter of 9 μm is spread by the angle of an aperture of optical fiber 20, and the object is exposed to the spread light and reflects it. The reflected light is received by optical fiber 20 in a significantly small quantity, as optical fiber 20 has the small core diameter of 9 μm, and this results in a poor S/N ratio, and spectrometry unit 40 providing measurement with low precision. Furthermore, when optical fiber 20 is used as a light receiving unit, it is better that the object is exposed to light in as small a spot as possible with the object's surface roughness, crystalline state and the like considered.

Condensing optical probe 30 is used in order to solve the above problem, and a condenser lens 31 is provided between a surface of the object and the end of optical fiber 20. Condenser lens 31 receives light that exits the end of optical fiber 20 and condenser lens 31 condenses the light on the surface of the object to reduce the light's spot in size. Note that in order to measure a film of the object in thickness, condensing optical probe 30 has a configuration that does not utilize interference of light that is attributed to an optical path difference between light reflected by the object and incident on condenser lens 31 and light reflected by condenser lens 31 at the exit surface. Accordingly, condensing optical probe 30 can have a distance WD1 to the object modified by adjusting a distance WD2 between the end of optical fiber 20 and condenser lens 31.

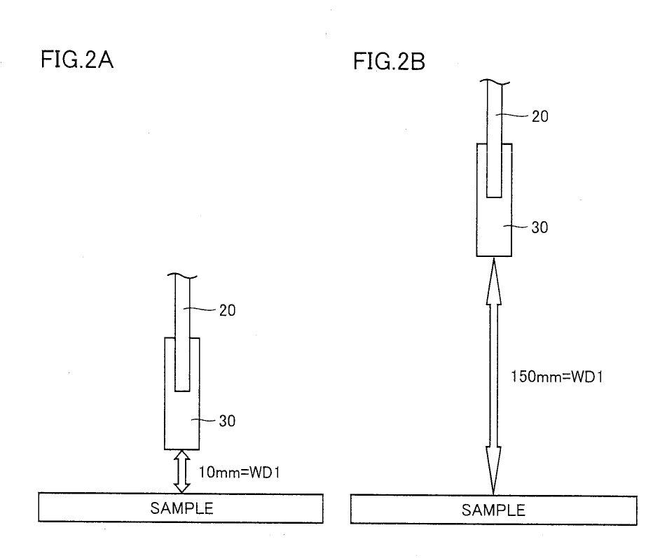

FIG. 2A and FIG. 2B schematically illustrate a distance between condensing optical probe 30 according to the first embodiment of the present invention and an object to be measured. FIG. 2A schematically shows condensing optical probe 30 and the object with distance WD1 of 10 mm therebetween, and FIG. 2B schematically shows condensing optical probe 30 and the object with distance WD1 of 150 mm therebetween. Film thickness measurement apparatus 100 that includes condensing optical probe 30 can thus measure a film of the object in thickness with higher precision without depending on distance WD1 to the object. FIG. 2A and FIG. 2B show condensing optical probe 30 and the object with distance WD1 of 10 to 150 mm therebetween by way of example, and distance WD1 is not limited to such values.

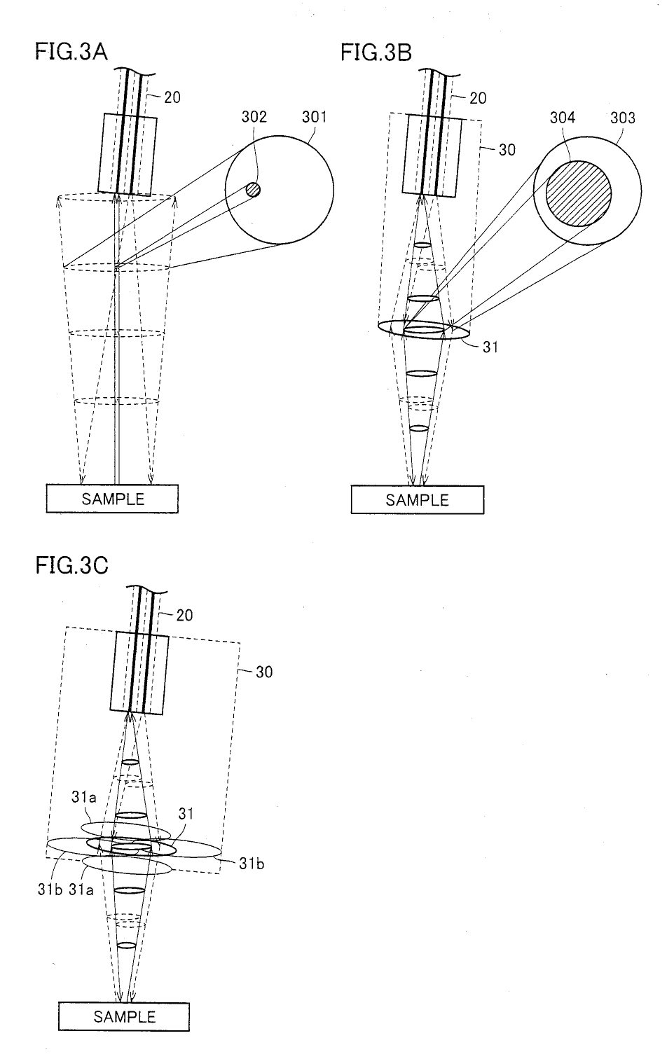

Furthermore, FIG. 3A to FIG. 3C are schematic diagrams for illustrating a principle of condensing optical probe 30 according to the first embodiment of the present invention. FIG. 3A shows an object to be measured directly exposed to measurement light that exits optical fiber 20, rather than through condensing optical probe 30. Optical fiber 20 outputs light, which, as shown in FIG. 3A, is in turn spread by the angle of the aperture of optical fiber 20, and reflected by the object and further spread. In FIG. 3A, the object reflects light of a range 301, of which optical fiber 20 can receive only a small range 302.

FIG. 3B shows condensing optical probe 30 provided to condense measurement light from optical fiber 20 to expose an object to be measured thereto. Optical fiber 20 outputs light, which, as shown in FIG. 3B, can be prevented by condenser lens 31 from spreading. In FIG. 3B, the object is exposed to light of a range 303, of which optical fiber 20 can receive a large range 304. Film thickness measurement apparatus 100 that includes condensing optical probe 30 can thus efficiently receive light reflected by the object. This provides an improved S/N ratio and thus allows spectrometry unit 40 to provide measurement with high precision.

While condensing optical probe 30 allows range 304 of light that optical fiber 20 can receive to match range 303 of light that the object is exposed to some extent, optical fiber 20, having as small a core diameter as 9 μm, necessitates condensing optical probe 30 to have an adjustment mechanism 32 (see FIG. 1) to positionally adjust condenser lens 31. Adjustment mechanism 32 initially determines a focal point along the z axis and then determines a position for condenser lens 31 along the x and y axes so that light reflected by the object enters optical fiber 20.

FIG. 3C shows a position of condenser lens 31, as adjusted by adjustment mechanism 32. As shown in FIG. 3C, adjustment mechanism 32 adjusts condenser lens 31 along the z axis (see a condenser lens 31a) and along the x and y axes (see a condenser lens 31b) to match range 304 of light that optical fiber 20 can receive to range 303 of light that the object is exposed to. Film thickness measurement apparatus 100 that includes condensing optical probe 30 can thus efficiently receive light reflected by the object.

If adjustment can be done by condensing optical probe 30 to achieve a perfect focusing position on a surface of the object, the object's ideal film thickness measurement can be obtained. In reality, however, the object's surface roughness, crystalline state and the like may result in failing to achieve a perfect focusing position. However, if condensing optical probe 30 receives a spot of light matching that of light exiting condensing optical probe 30 to some extent, optical fiber 20 having the core diameter of 9 μm serves as a pinhole, and film thickness measurement apparatus 100 can measure a film of the object in thickness.

Spectrometry unit 40 measures a spectrum of the measurement light reflected and having passed through the core diameter of 9 μm of optical fiber 20, and outputs a measurement result to data processing unit 50. More specifically, spectrometry unit 40 includes a diffraction grating (or a grating) 41, a detection unit 42, a cutoff filter 43, and a shutter 44.

Cutoff filter 43, shutter 44, and diffraction grating 41 are disposed on an optical axis AX1. Cutoff filter 43 is an optical filter for limiting a wavelength component outside a measurement range included in measurement light reflected, having passed through the pinhole and entering spectrometry unit 40, and cuts off the wavelength component outside the measurement range, in particular. Shutter 44 is used to interrupt light that enters detection unit 42 for example when detection unit 42 is reset. Shutter 44 is representatively an electromagnetically driven, mechanical shutter.

Diffraction grating 41 receives reflected measurement light, splits it, and guides each split wave to detection unit 42. Specifically, diffraction grating 41 is a reflective diffraction grating, and it is configured to reflect a diffracted wave for each predetermined wavelength interval in a corresponding direction. When diffraction grating 41 thus configured receives a reflected measurement wave, each wavelength component included therein is reflected in a corresponding direction and enters detection unit 42 at a predetermined detection area. Note that this wavelength interval corresponds to a wavelength resolution in spectrometry unit 40. Diffraction grating 41 is representatively a flat focus type, spherical surface grating.

Detection unit 42 outputs an electrical signal according to light intensity of each wavelength component included in the reflected measurement light that has been split by diffraction grating 41 to measure a reflectance spectrum of the object to be measured. Detection unit 42 is formed of an InGaAs array or the like sensitive to the infrared range.

Note that diffraction grating 41 and detection unit 42 are appropriately designed depending on a measurement wavelength range, a measurement wavelength interval and the like for an optical property.

Data processing unit 50 subjects the reflectance spectrum obtained by detection unit 42 to various types of data processing (representatively, Fast Fourier Transform (FFT), a maximum entropy method (hereinafter also referred to as “MEM”) and a noise removal process) to measure each layer configuring the object in thickness. Furthermore, data processing unit 50 is also capable of analyzing the reflectance of each layer of the object, and the object's layered structure. Such processing will be described later in detail. Then, data processing unit 50 outputs an optical property including a film thickness of the object as measured.

Analytical Examination of Reflected Light

Initially, reflected light observed when an object to be measured is exposed to measurement light will mathematically and physically be discussed hereinafter.

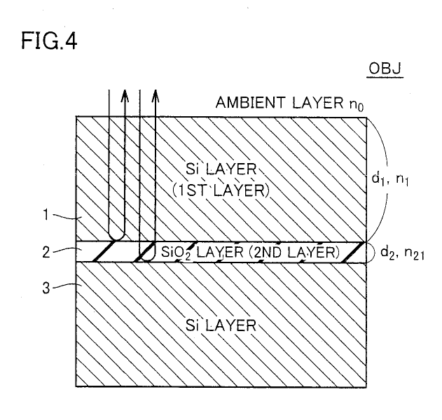

FIG. 4 shows an object OBJ in a schematic cross section by way of example to be measured with film thickness measurement apparatus 100 according to the first embodiment of the present invention.

With reference to FIG. 4, an SOI substrate will be considered as a representative example of object OBJ. More specifically, object OBJ has a 3 layer structure having a Si layer 1, a base Si layer 3 (or a substrate layer), and a SiO₂ layer 2 (or a BOX layer) therebetween. Film thickness measurement apparatus 100 provides light for exposure, which enters object OBJ from an upper side as seen on the plane of the sheet of the drawing for the sake of illustration. In other words, the measurement light first enters Si layer 1 for the sake of illustration.

In order to facilitate understanding the present invention, the measurement light having entered object OBJ and reflected at the interface of Si layer 1 and SiO₂ layer 2 will be considered. In the following description, each layer will be represented with a subscript i. More specifically, air, vacuum or a similar ambient layer corresponds to a subscript “0”, Si layer 1 of object OBJ corresponds to a subscript “1”, and SiO₂ layer 2 of object OBJ corresponds to a subscript “2”. Furthermore, each layer has an index of refraction represented with subscript i, i.e., by an index of refraction nᵢ.

An interface of layers having mutually different indices of refraction nᵢ provides reflection of light, and accordingly, each boundary plane between an i layer and an i+1 layer having different indices of refraction provide amplitude reflectances (or Fresnel coefficients) r^{(P)}_{i, i+1} and r^{(S)}_{i, i+1} for a P polarization component and an S polarization component, as follows:

$${r}_{i , i + 1}^{( P )} = \frac{{n}_{i + 1} cos {φ}_{i} - {n}_{i} cos {φ}_{i + 1}}{{n}_{i + 1} cos {φ}_{i} + {n}_{i} cos {φ}_{i + 1}}$$

$${r}_{i , i + 1}^{( S )} = \frac{{n}_{i} cos {φ}_{i} - {n}_{i + 1} cos {φ}_{i + 1}}{{n}_{i} cos {φ}_{i} + {n}_{i + 1} cos {φ}_{i + 1}}$$

where φᵢ represents an angle of incidence on the i layer. The angle of incidence φᵢ is calculable from an angle of incidence on the uppermost, ambient layer (or the 0 layer) in accordance with Snell laws of refraction, as follows:

N₀ sin φ₀=Nᵢ sin φᵢ.

When a layer has a thickness allowing light to interfere, light reflected at a reflectance represented by the above expression travels through the layer back and forth repeatedly. Accordingly, light directly reflected at an interface with an adjacent layer and light having been reflected through a layer in a multiple manner have optical paths, respectively, different in length, and will thus have mutually different phases, and interference of light thus arises at a surface of Si layer 1. When a phase angle βᵢ of light in the i layer is introduced to indicate an effect of interference of light in each layer, it can be represented as follows:

$${β}_{i} = 2 π ( \frac{{d}_{i}}{λ} ) {n}_{i} cos {φ}_{i}$$

where dᵢ represents the i layer in thickness and λ represents incident light in wavelength.

For the sake of simplicity, when object OBJ is exposed to light perpendicularly, i.e., for angle of incidence ᵢ=0, P polarization and S polarization are no longer distinguished, and amplitude reflectance at each interlayer interface and phase angle β₁ in a thin film are provided as follows:

$${r}_{01} = \frac{{n}_{0} - {n}_{1}}{{n}_{0} + {n}_{1}}$$

$${r}_{12} = \frac{{n}_{1} - {n}_{2}}{{n}_{1} + {n}_{2}}$$

$${β}_{1} = 2 π ( \frac{{d}_{1}}{λ} ) {n}_{1}$$

Furthermore, object OBJ of the 3-layer system shown in FIG. 4 has reflectance R, as follows:

$$R = \frac{{r}_{01}^{2} + {r}_{12}^{2} + 2 {r}_{01} {r}_{12} cos 2 {β}_{1}}{1 + {r}_{01}^{2} {r}_{12}^{2} + 2 {r}_{01} {r}_{12} cos 2 {β}_{1}}$$

In the above expression, when frequency transformation (Fourier transform) is considered for phase angle β₁, a phase factor, or cos 2β₁, will be nonlinear with respect to reflectance R. Accordingly, transformation is done to a function having linearity for phase factor cos 2β₁. As an example, reflectance R is transformed as indicated by the following expression to define a unique variable, a “wave number transformed reflectance” R′:

$$\begin{matrix}{R}^{′} ≡ \frac{R}{1 - R} = \frac{{r}_{01}^{2} + {r}_{12}^{2}}{( 1 - {r}_{01}^{2} ) ( 1 - {r}_{12}^{2} )} + \frac{2 {r}_{01} {r}_{12}}{( 1 - {r}_{01}^{2} ) ( 1 - {r}_{12}^{2} )} cos 2 {β}_{1} \\ ≡ {R}_{a} + {R}_{b} cos 2 ( \frac{2 π {n}_{1}}{λ} ) {d}_{1}\end{matrix}$$

where (2πn₁)/λ is a wave number K when light (or an electromagnetic wave) propagates through a substance, or a layer (i.e., a propagation number).

Wave number transformed reflectance R′ will serve as a primary expression for phase factor cos 2β₁, and will have linearity. In the expression, Rₐ is an intercept for wave number transformed reflectance R′, and R_{b} is a gradient for wave number transformed reflectance R′. More specifically, wave number transformed reflectance R′ is a function for linearizing a value of reflectance R for each wavelength for phase factor cos 2β₁ involved in frequency transformation. Note that such a function for linearization for such a phase factor may be a function 1/(1−R).

Accordingly, a wave number K₁ in Si layer 1 as a target can be defined as follows:

$${K}_{1} ≡ \frac{2 π {n}_{1}}{λ}$$

When Si layer 1 allows wavelength λ with speed of light s therein and a vacuum allows wavelength λ with speed of light c therein, then, index of refraction n₁ is represented as c/s. Furthermore, light which travels through Si layer 1 in a direction x causes an electromagnetic wave E(x, t) represented with wave number K₁, an angular frequency ω, and a phase δ as E(x, t)=E₀exp[j(ωt−K₁x+δ)]. In other words, an electromagnetic wave's propagation characteristic in Si layer 1 depends on wave number K₁. From these relationships, it can be seen that light having wavelength λ, in a vacuum has its speed of light reduced in a layer and the wavelength is also increased from λ to λ/n₁. With such a wavelength dispersion phenomenon considered, wave number transformed reflectance R′ is defined as follows:

R′(K₁)=Rₐ+R_{b} cos 2K₁d₁

From this relationship, when wave number transformed reflectance R′ is subjected to frequency transformation (or Fourier transform) for wave number K, a peak appears in a periodic component corresponding to a film thickness d₁, and identifying this peak's position allows film thickness d₁ to be calculated.

In other words, a correspondence between a reflectance spectrum measured from object OBJ and a reflectance for each wavelength is transformed to a correspondence between a wave number calculated from each wavelength and wave number transformed reflectance R′ calculated according to the foregoing relational expression (or a wave number distribution characteristic) and a function of wave number transformed reflectance R′ including wave number K is subjected to frequency transformation for wave number K, and from a peak appearing in a characteristic after this frequency transformation, a thickness of Si layer 1 of object OBJ can be calculated. This means obtaining a value in amplitude of each wave number component that is included in the wave number distribution characteristic, and calculating the thickness of Si layer 1 based on a wave number component thereof having a large value in amplitude. Note that, as will be described later, analyzing a wave number component having a large value in amplitude from the wave number distribution characteristic can be done in one of FFT or a similar method using discrete Fourier transform and a method using optimization processing (such as maximum entropy method (MEM) or the like).

In the definition of wave number transformed reflectance R′, while Rₐ and R_{b} are values irrelevant to intralayer interference phenomenon, they are dependent on amplitude reflectance at an interface between each layer including index of refraction n₁ of Si layer 1. Accordingly, if index of refraction n₁ has wavelength dispersion, its value will be a value of a function depending on wavelength (or wave number K), and will not be a fixed value for wave number K. Accordingly, when Fourier transform is represented by ⊃, and R′, Rₐ, R_{b}, cos 2K₁d₁ having undergone Fourier-transform with wave number K provide functions or power spectra represented as P, Pₐ, P_{b}, F, respectively, the following expression is established:

P⊃Pₐ+(P_{b}*F)

where * represents convolution.

In the expression, a component in Pₐ depending on film thickness is relatively small and has a peak independent of power spectrum F, and thus does not affect power spectrum F.

In contrast, P_{b} is convoluted with power spectrum F and a component in P_{b} depending on film thickness will modify that of power spectrum F depending on film thickness. However, P_{b} is irrelevant to intralayer interference phenomenon and affected only by wavelength dependence of an index of refraction in two adjacent layers, and the component in P_{b} depending on film thickness for wave number K is neglectably smaller than that of F depending on film thickness for wave number K. For example, when it is assumed that R_{b} is a periodic function of a film thickness q and that its Fourier transform, or P_{b}, has modulated through the convolution a component of power spectrum F attributed to film thickness d, then a peak appearing as a spectrum will be “d−q” or “d+q”. However, q has a significantly small value, and q thus has a limited effect on film thickness d of the peak's position.

Furthermore, in applying Fourier transform, as will be described later, a maximum thickness of a layer to be measured is considered and Nyquist's sampling theorem is followed to sample wave number transformed reflectance R′ at appropriate sampling intervals for an appropriate number of samples. Wave number transformed reflectance R′ thus sampled is used to calculate a power spectrum having a film thickness resolution r, and when it is compared with a component of P_{b} attributed to film thickness q, the latter has a large possibility to be smaller than the former (q<r), and would hardly affect measurement of film thickness d.

Thus, a calculated reflectance spectrum can be transformed into a function for a wave number with wavelength dispersion in a thin film considered and Fourier transform can then be applied to calculate the thin film in thickness accurately.

Note that while in the above description a reflectance spectrum is used by way of example, a transmittance spectrum may also be used. In that case, when measured transmittance is represented as T and “wave number transformed transmittance” is represented as T′, the following relational expression is provided:

$${T}^{′} ≡ \frac{1}{T} = {T}_{a} + {T}_{b} cos 2 {Kd}_{1}$$

When a transmittance spectrum is used, transmittance T will also be nonlinear for phase factor cos 2β₁. Accordingly, for the same ground as described above, wave number transformed transmittance T′ having linearity for phase factor cos 2β₁ is adopted. According to the above expression, wave number transformed transmittance T′ will serve as a primary expression for phase factor cos 2β₁, and a procedure similar to that described above can be followed to calculate thin film in thickness accurately. In other words, wave number transformed transmittance T′ is a function for linearizing a value of transmittance T for each wavelength for phase factor cos 2β₁ involved in frequency transformation.

Again, with reference to FIG. 4, a reflection of light from an interface of SiO₂ layer 2 and base Si layer 3 will be considered. When Si layer 1 has index of refraction n₁ and thickness d₁ and SiO₂ layer 2 has index of refraction n₂ and thickness d₂, then wave number transformed reflectance R′ is represented as follows:

$${R}^{′} = {R}_{a} + {R}_{b} cos 2 {K}_{1} {d}_{1} + {R}_{c} cos 2 {K}_{2} {d}_{2} + {R}_{d} cos 2 ( {K}_{1} {d}_{1} + {K}_{2} {d}_{2} ) + {R}_{e} cos 2 ( {K}_{1} {d}_{1} - {K}_{2} {d}_{2} )$$

$${K}_{1} ≡ \frac{2 π {n}_{1}}{λ}$$

$${K}_{2} ≡ \frac{2 π {n}_{2}}{λ}$$

Herein, if the Si layer 1 thickness d₁ and the SiO₂ layer 2 thickness d₂ are separately calculated, wave number transformed reflectances R₁′ (K₁) and R₂′ (K₂) provided through transformation with wave numbers K₁ and K₂, respectively, are used. Specifically, they are represented as follows:

$${R}_{1}^{′} ( {K}_{1} ) = {R}_{a} + {R}_{b} cos 2 {K}_{1} {d}_{1} + {R}_{c} cos 2 {K}_{1} {d}_{2}^{′} + {R}_{d} cos 2 {K}_{1} ( {d}_{1} + {d}_{2}^{′} ) + {R}_{e} cos 2 {K}_{1} ( {d}_{1} - {d}_{2}^{′} )$$

$${R}_{2}^{′} ( {K}_{2} ) = {R}_{a} + {R}_{b} cos 2 {K}_{2} {d}_{1}^{′} + {R}_{c} cos 2 {K}_{2} {d}_{2} + {R}_{d} cos 2 {K}_{2} ( {d}_{1}^{′} + {d}_{2} ) + {R}_{e} cos 2 {K}_{2} ( {d}_{1}^{′} - {d}_{2} )$$

$${d}_{1}^{′} = \frac{{n}_{1}}{{n}_{2}} {d}_{1}$$

$${d}_{2}^{′} = \frac{{n}_{2}}{{n}_{1}} {d}_{2}$$

In these expressions, while d₁′ and d₂′ are not correct film thickness, film thickness d₁ can properly be obtained from a peak in a power spectrum corresponding to a second term of wave number transformed reflectance R₁′ (K₁) and film thickness d₂ can properly be obtained from a peak in a power spectrum corresponding to a third term of wave number transformed reflectance R₂′ (K₂).

Note that in reality, Si layer 1 and SiO₂ layer 2 have their respective indices of refraction approximate to each other, and their interface often provides reflectance smaller than another interface does. As a result, wave number transformed reflectance's function includes R_{c} smaller in value than R_{b} and R_{d} and it is also often the case that it is difficult to identify from a power spectrum a peak corresponding to the third term of wave number transformed reflectance R₂′ (K₂). In such a case, calculating a film thickness (d₁′+d₂) at a peak position of a power spectrum that corresponds to a fourth term of wave number transformed reflectance R₂′ (K₂) and a film thickness (d₁′) at a peak position of a power spectrum that corresponds to a second term of wave number transformed reflectance R₂′ (K₂) and obtaining a difference therebetween allow film thickness d₂ to be calculated.

Wavelength Range and Wavelength Resolution

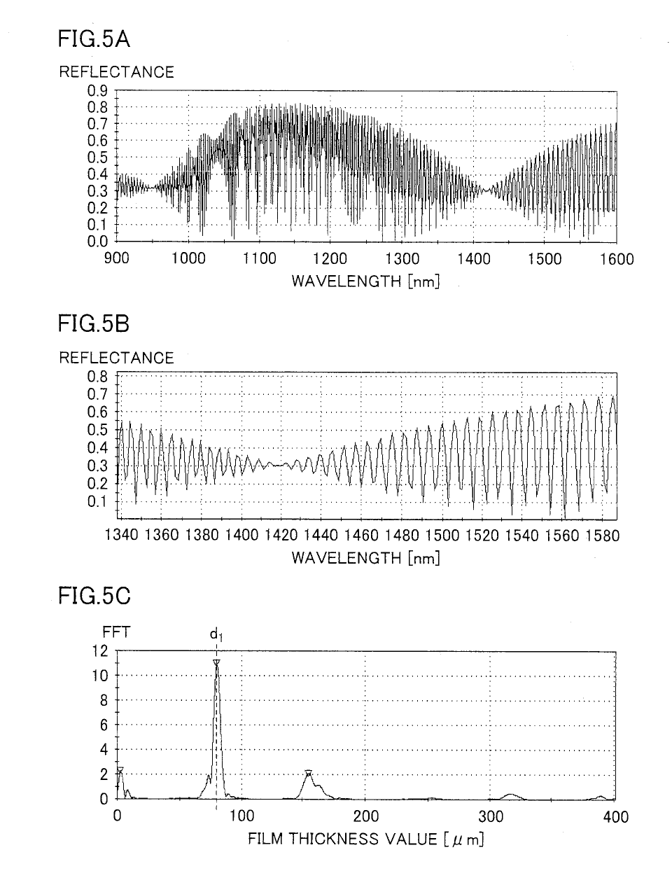

FIG. 5A to FIG. 5C show a result of measuring an SOI substrate with film thickness measurement apparatus 100 according to the first embodiment of the present invention. FIG. 5A to FIG. 5C show examples of measurement with measurement light having a wavelength range of 900-1600 nm (see FIG. 5A) and measurement light having a wavelength range of 1340-1600 nm (see FIG. 5B). Note that diffraction grating 41 having appropriate characteristics depending on the wavelength for measurement is selected and in each example, reflected light is received by detection unit 42 (see FIG. 1) having the same number of detection points (or detection channels), e.g., 512 channels. In other words, the smaller the wavelength range is, the smaller the wavelength interval per detecting point (i.e., the wavelength resolution) is.

According to the above analytical examination, the reflectance measured should vary with wavelength periodically.

While the FIG. 5A measurement result indicates a sign indicating that reflectance varies with wavelength periodically, sufficient precision to measure film in thickness is not obtained.

In contrast, the FIG. 5B measurement result indicates reflectance's peak and valley clearly and also allows reflectance's variation cycle to be measured. FIG. 5C represents the FIG. 5B measurement result (or reflectance spectrum) that has been transformed to the function of wave number transformed reflectance R′ described above, and then subjected to frequency transformation for wave number K. A value corresponding to a major peak appearing in FIG. 5C can be determined as the thickness of Si layer 1.

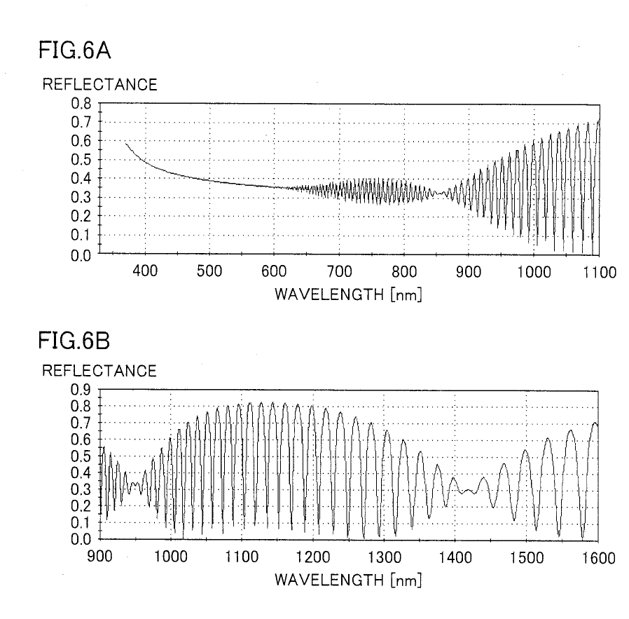

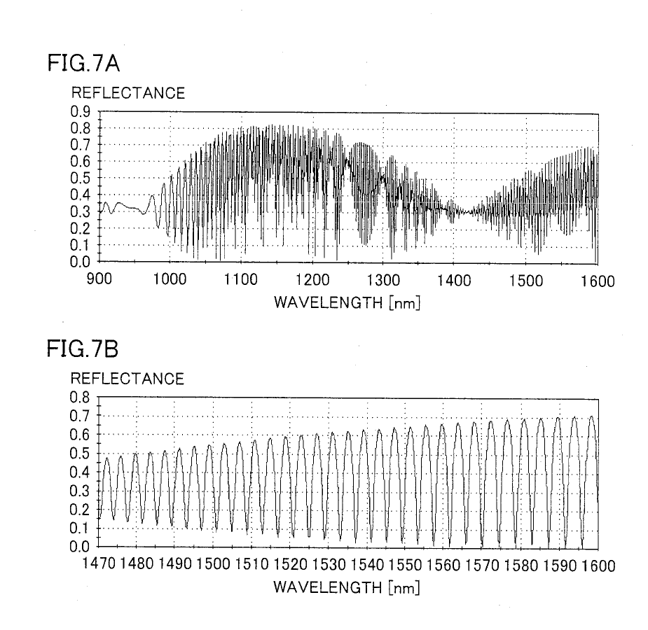

Furthermore, FIG. 6A, FIG. 6B, and FIG. 7A, FIG. 7B indicate other results of measuring SOI substrates.

FIG. 6A and FIG. 6B show another result of measuring SOI substrates with film thickness measurement apparatus 100 according to the first embodiment of the present invention. FIG. 6A and FIG. 6B indicate examples of measurement in examples with Si layer 1 having a thickness of 10.0 μm (a designed value) and SiO₂ layer 2 having a thickness of 0.3 μm (a designed value). Furthermore, FIG. 6A shows an example with measurement light having a wavelength component in a visible range (330 to 1100 nm), and FIG. 6B shows an example with measurement light having a wavelength component in an infrared range (900 to 1600 nm). As has been set forth above, each example employs detection unit 42 (see FIG. 1) having the same number of detection points (or detection channels).

As indicated in FIG. 6A, it can be seen that when the measurement light having a wavelength component in the visible range is used, for a wavelength range longer than about 860 nm, reflectance exhibits a periodical behavior, whereas for a visible range shorter than that, it does not exhibit significant periodical variation. In contrast, as indicated in FIG. 6B, it can be seen that when the measurement light having a wavelength component in the infrared range is used, reflectance periodically varies significantly.

FIG. 7A and FIG. 7B show still another result of measuring SOI substrates with film thickness measurement apparatus 100 according to the first embodiment of the present invention. FIG. 7A and FIG. 7B indicate examples of measurement in examples with Si layer 1 having a thickness of 80.0 μm (a designed value) and SiO₂ layer 2 having a thickness of 0.1 μm (a designed value). Furthermore, FIG. 7A shows an example with measurement light having a wavelength component in an infrared range (900 to 1600 nm), and FIG. 7B shows an example with measurement light having a wavelength component in a narrower infrared range (1470 to 1600 nm). As has been set forth above, each example employs detection unit 42 (see FIG. 1) having the same number of detection points (or detection channels).

As indicated in FIG. 7A, it can be seen that even when measurement light having a wavelength component in an infrared range is used, the reflectance measured does not present significant periodical variation. In contrast, as indicated in FIG. 7B, it can be seen that when measurement light having a wavelength component in a narrower infrared range is used, the reflectance periodically varies significantly.

From the above examples of measurement, measuring a relatively thick layer in thickness with high precision would require appropriately setting the measurement light's wavelength range and wavelength resolution. This is attributed to the fact that intralayer interference of light is utilized for measurement and that detection unit 42 has a limited wavelength resolution to resolve reflected light and accordingly, a procedure described hereinafter is preferably followed to appropriately set measurement light in wavelength.

In the following discussion, film is measured in thickness in a range having a lower limit value dₘᵢₙ and an upper limit value dₘₐₓ for the sake of illustration. Furthermore, detection unit 42 detects wavelengths in a range having a lower limit value λₘᵢₙ and an upper limit value λₘₐₓ for the sake of illustration. Note that measurement light source 10 (see FIG. 1) may emit measurement light in any wavelength range that includes the wavelength detection range of detection unit 42. Furthermore, detection unit 42 (see FIG. 1) has a number Sₚ of detection points (or detection channels) for the sake of illustration.

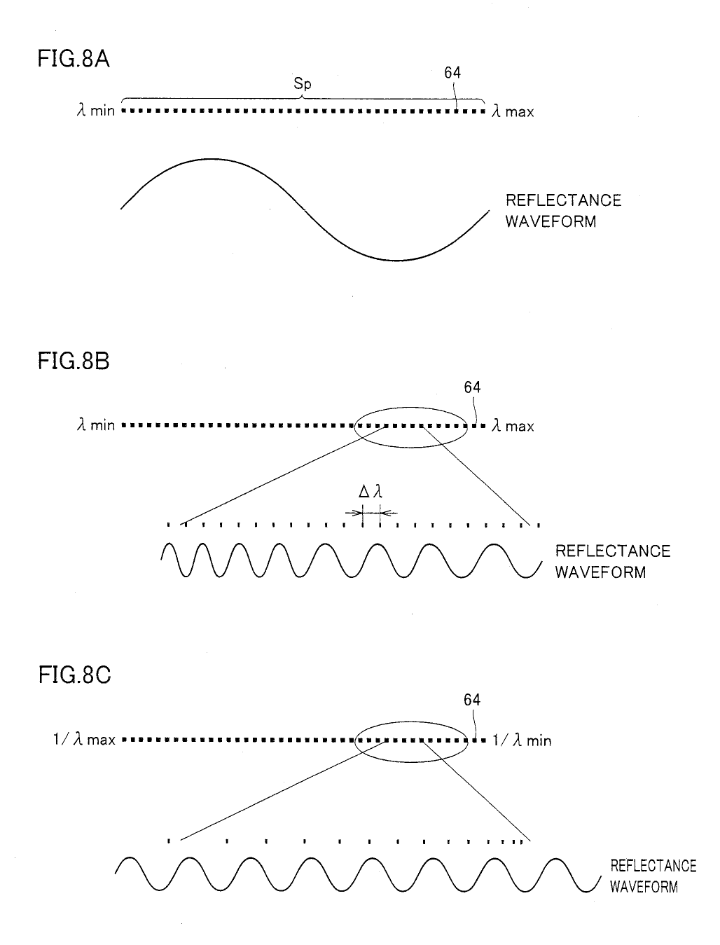

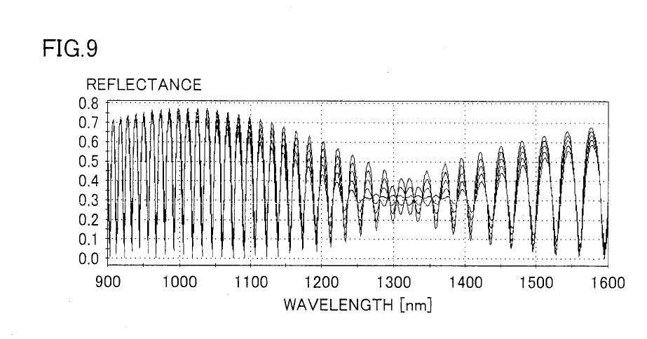

FIG. 8A to FIG. 8C are diagrams for illustrating a relationship between a film thickness measurement range and the detection unit 42 wavelength detection range and number of detection points according to the first embodiment of the present invention.

(1) Relationship Between Lower Limit Value dₘᵢₙ of Film Thickness Measurement Range and Wavelength Detection Range

The above described film thickness measurement method requires finding a wavelength that causes interference of light within an object to be measured, and accordingly, detection unit 42 is required to have a wavelength range that can cause interference of light. In other words, as shown in FIG. 8A, the object measured exhibits some reflectance, which is required to have a waveform varying by at least one cycle in the wavelength detection range of detection unit 42.

This means that it is necessary that the optical distance caused as detection unit 42 has its wavelength detection range varied from lower limit value λₘᵢₙ to upper limit value λₘₐₓ varies by at least a distance corresponding to at least going and returning through the film thickness of the object. Accordingly, the thickness measurement range's lower limit value dₘᵢₙ and the measurement light's wavelength range are required to have a relationship satisfying the following conditional expression (1):

$${d}_{min} ≧ \frac{{λ}_{min} \cdot {λ}_{max}}{2 ( {λ}_{max} \cdot {n}_{min} - {λ}_{min} \cdot {n}_{max} )} \qquad ( 1 )$$

where nₘᵢₙ represents an index of refraction for wavelength λₘᵢₙ and nₘₐₓ represents an index of refraction for wavelength λₘₐₓ.

(2) Relationship Between Upper Limit Value d_{Max} of Film Thickness Measurement Range and Number of Detection Points

As shown in FIG. 8B, when measurement light has a longer wavelength, the object measured exhibits a reflectance waveform having a longer period. FIG. 8C shows a reflectance waveform, which corresponds to the FIG. 8B reflectance waveform transformed to a coordinate of a wave number (1/f). If each array element, such as InGaAs, is disposed at equal intervals in wavelength, it can be seen that the array element is disposed at larger intervals for smaller wave numbers.

Accordingly, accurately sampling a reflectance waveform which periodically varies with wave number requires that each array element be disposed at intervals (or there be provided a wavelength resolution Δλ) satisfying Nyquist's sampling theorem and the film thickness measurement range's upper limit value dₘₐₓ is determined by the condition that this sampling theorem is satisfied.

Detection unit 42 has wavelength resolution Δλ, which can be represented with the number of detection points (or detection channels) Sₚ as Δλ=(λₘₐₓ−λₘᵢₙ)/Sₚ.

When the measurement light has a longer wavelength, the reflectance has a waveform having a longer period and accordingly, if the reflectance has a waveform having an extreme (a peak or a valley) at upper limit value λₘₐₓ of the measurement light, and an extreme adjacent to that at upper limit value λₘₐₓ (in other words, a peak or a valley adjacent to that at upper limit value λₘₐₓ) is caused at a wavelength λ₁, then, upper limit value λₘₐₓ and the film thickness measurement range's upper limit value dₘₐₓ must satisfy the following condition:

$${d}_{max} = \frac{{λ}_{1} \cdot {λ}_{max}}{2 ( {λ}_{max} \cdot {n}_{1} - {λ}_{1} \cdot {n}_{max} )}$$

If a layer to be measured is relatively large in thickness, then it can be assumed that nₘₐₓ≈n₁, and the foregoing condition can be represented as the following conditional expression (2):

$${d}_{max} = \frac{{λ}_{1} \cdot {λ}_{max}}{2 \cdot {n}_{max} ( {λ}_{max} - {λ}_{1} )} \qquad ( 2 )$$

For wavelength resolution Δλ, the following condition must be satisfied:

$$Δ λ = \frac{{λ}_{max} - {λ}_{min}}{{S}_{p}} ≦ \frac{{λ}_{max} - {λ}_{1}}{2}$$

When the relational expression of upper limit value dₘₐₓ is substituted into the forgoing relational expression of wavelength resolution Δλ to remove the term of λ₁, the relational expression of wavelength resolution Δλ can be represented as the following conditional expression (3):

$$Δ λ = \frac{{λ}_{max} - {λ}_{min}}{{S}_{p}} ≦ \frac{{λ}_{max}^{2}}{2 ( {λ}_{max} + 2 \cdot {n}_{max} \cdot {d}_{max} )} \qquad ( 3 )$$

As a result of the above discussion, once a film thickness measurement range (lower limit value dₘᵢₙ to upper limit value dₘₐₓ) requested for the object to be measured has been determined, it is necessary to define the measurement light's wavelength range (lower limit value λₘᵢₙ to upper limit value λₘₐₓ) and the number of detection points Sₚ to satisfy conditional expressions (1) and (2).

Exemplary Calculation

Hereinafter will be described an example of calculation for a condition required in measuring Si layer 1 of the SOI substrate as shown in FIG. 4 in thickness.

In this exemplary calculation, it is assumed that the SOI substrate's Si layer 1 has upper limit value dₘₐₓ of 100 μm and index of refraction n having a constant value (n=3.5) irrespective of wavelength. Note that, in this exemplary calculation, lower limit value dₘᵢₙ of Si layer 1 of the SOI substrate is not taken into consideration.

When the above presupposed values are substituted into conditional expressions (2) and (3), upper limit value λₘₐₓ=1424.0 nm and wavelength resolution Δλ=1.445375 nm are obtained. Accordingly, if an object having a maximum of 100 μm in thickness is measured in thickness via detection unit 42 having 512 channels, it can be understood that measurement light including a wavelength range of about 684-1424 nm can be used to detect reflected light of that range via detection unit 42 (wavelength resolution Δλ=1.4453125 nm).

Note, however, that wavelength resolution Δλ calculated by the above conditional expression describes a theoretical minimum specification, and in actual measurement it is preferable to further increase precision to be higher than wavelength resolution Δλ calculated. More preferably, it is recommendable to increase precision about several times (2-4 times, for example). Note that increasing precision means setting wavelength resolution Δλ to have a smaller value.

In other words, in reality, a film thickness measurement apparatus may provide impaired spectral accuracy depending on an effect of the angle of the measurement light incident on the object to be measured, an effect of the angle of an aperture when a condensing lens system is used, and the like. This results in a power spectrum having a peak reduced in height and makes it difficult to calculate film thickness. If FFT or the like using a finite number of sampled values to perform frequency transformation discretely is used, it may be significantly affected by aliasing and wave number transform may involve a large transform error. Furthermore, some object to be measured provides a significantly varying refractive index dispersion for some wavelength range, and there is a possibility of partially mismatching a condition.

Outline of Film Thickness Calculation Process

As has been described above, an object can be calculated in thickness from a reflectance spectrum's periodicity. More specifically, a detected reflectance spectrum is subjected to frequency transformation to obtain a power spectrum, and film thickness can be calculated from a peak appearing in that power spectrum. In reality, such a power spectrum is calculated through discrete Fourier transform, such as FFT. With FFT, however, a power spectrum which sufficiently reflects periodicity may not be obtained. Accordingly, the present invention in the first embodiment provides film thickness measurement apparatus 100 configured to be capable of performing a power spectrum calculation method by FFT or a similar discrete Fourier transform and in addition thereto optimization processing (such as MEM). In other words, the present invention in the first embodiment provides film thickness measurement apparatus 100 to perform Fourier transform and optimization processing selectively or together depending on the reflectance spectrum detected. For the details of MEM, see Waveform Data Processing for Scientific Measurement; Techniques to Use Microcomputers/Personal Computers in Measurement Systems, edited by Shigeo MINAMI, CQ Publishing Co., Ltd., Aug. 1, 1992, 10th edition, for example.

Furthermore, the present invention in the first embodiment provides film thickness measurement apparatus 100 configured to be also capable of performing a method to calculate film in thickness analytically from a reflectance spectrum detected, as described above, and in addition thereto, a method using a deviation between a reflectance spectrum theoretically calculated from a physical model calculated from an object to be measured and an actually detected reflectance spectrum to exploratively calculate the object's optical property value(s), i.e., fitting.

For the FIG. 4 SOI substrate or a similar object having a first, Si layer 1 layer larger in thickness by at least two digits than a second, SiO₂ layer 2, fitting may not allow each layer to be calculated in thickness with sufficient precision.

FIG. 9 shows a result of measuring a reflectance spectrum for the SOI substrate. FIG. 9 shows an example of measurement with the first, Si layer 1 having a thickness of 100 μm and the second, SiO₂ layer 2 having a thickness varying in a range of 0.48-0.52 μm by 0.1 μm at a time. It can be seen that, as shown in FIG. 9, while the second, SiO₂ layer 2 varies in thickness, the reflectance spectrum measured does not have large variation. In other words, this means that when such an object to be measured is measured, it exhibits a reflectance spectrum affected mainly by the first, Si layer 1, and if the second, SiO₂ layer 2 has a parameter varied, the reflectance spectrum cannot be fitted sufficiently.

Accordingly, the present embodiment provides film thickness measurement apparatus 100 to perform one of the above described Fourier transform, optimization processing, and fitting, or any combination thereof as appropriate to accurately analyze each of a plurality of different layers of an SOI substrate or a similar object in thickness independently. The present embodiment provides film thickness measurement apparatus 100 to perform a film thickness calculation process, as will more specifically be described hereinafter. Note that the film thickness calculation process is performed by data processing unit 50 (see FIG. 1).

Configuration of Data Processing Unit

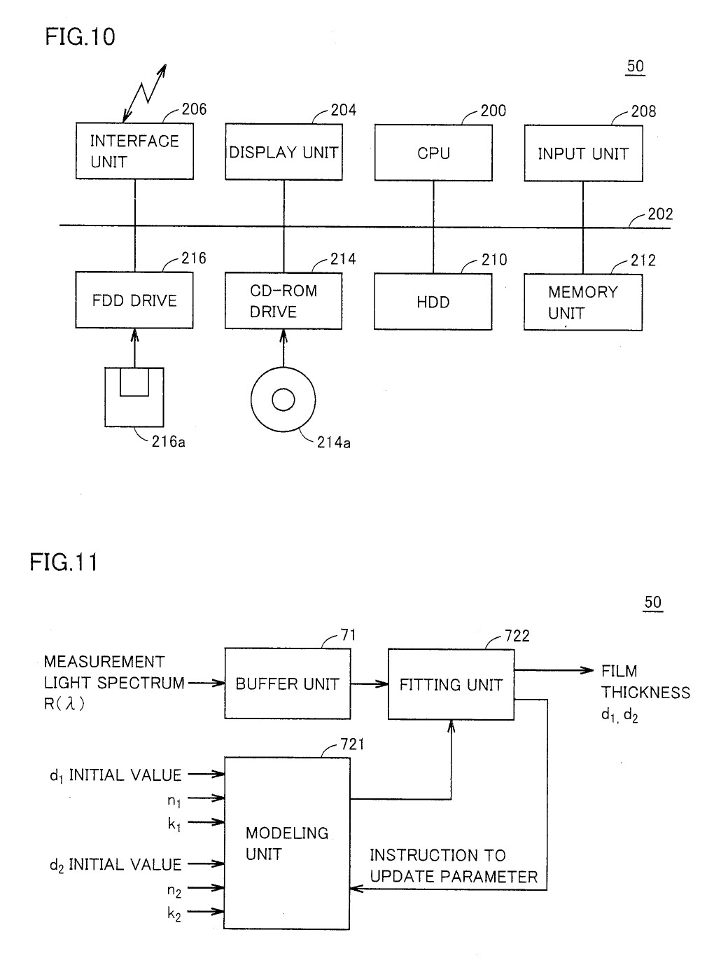

FIG. 10 is a schematic diagram showing a schematic hardware configuration of data processing unit 50 according to the first embodiment of the present invention.

Referring to FIG. 10, data processing unit 50 includes a central processing unit (CPU) 200 representatively implemented as a computer and executing various programs including an operating system (OS), a memory unit 212 to temporarily store data required by CPU 200 to execute a program, and a hard disk unit (a hard disk drive (HDD)) 210 to store a program executed by CPU 200 in a non volatile manner. Furthermore, hard disk unit 210 has a program previously stored therein for implementing a process as will be described later, and the program is read by a flexible disk drive (FDD) 216 or a CD-ROM drive 214 from a flexible disk 216a or a compact disk-read only memory (CD-ROM) 214a, respectively. CPU 200 receives instructions from the user or the like via an input unit 208 formed of a keyboard, a mouse and the like, and also outputs to a display unit 204 a measurement result or the like provided as a program is executed. Each unit is connected to each other via a bus 202.

Operation Process Structure

The present invention in the first embodiment allows data processing unit 50 to perform an appropriate processing pattern depending on the type of an unknown value of parameters (e.g., material, film thickness, film thickness range, index of refraction, extinction coefficient, and the like) of each layer of the object, how many such unknown values exist, and the analytic accuracy thereof to measure the object in thickness. In the following description will be described calculating two stacked, first and second layers, such as provided for the FIG. 4 SOI substrate, in thickness independently, with their indices of refraction and extinction coefficients known. Note that the following description is by way of example, and it is not limited to the processing pattern indicated hereinafter, and may be a different processing pattern. Furthermore, a similar procedure can also be employed to calculate three or more stacked layers in thickness independently.

One Example of Processing Pattern

This processing pattern is an example of the film thickness calculation process executable when the first and second layers' respective indices of refraction and extinction coefficients are known. In this processing pattern, each layer's thickness is determined by fitting. The fitting representatively employs least squares by way of example.

FIG. 11 is a block diagram showing a control structure to perform the film thickness calculation process related to a processing pattern according to the first embodiment of the present invention. The FIG. 11 block diagram is implemented by CPU 200 reading a program that is previously stored in hard disk unit 210 or the like into memory unit 212 or the like, and executing the program.

With reference to FIG. 11, data processing unit 50 (see FIG. 1) includes a buffer unit 71, a modeling unit 721, and a fitting unit 722 as its functions.

Buffer unit 71 temporarily stores a measured reflectance spectrum R(λ) output from spectrometry unit 40 (see FIG. 1). More specifically, spectrometry unit 40 outputs a value of a reflectance for each predetermined wavelength resolution, and buffer unit 71 associates a wavelength with a reflectance for that wavelength and thus stores them therein.

Modeling unit 721 receives a parameter associated with an object to be measured, determines therefrom a model expression (or function) indicating a theoretical reflectance for the object, and follows the determined function to calculate a theoretical reflectance (or spectrum) for each wavelength. The theoretical reflectance calculated for each wavelength is output to fitting unit 722. More specifically, modeling unit 721 receives the first layer's index of refraction n₁ and extinction coefficient k₁, and the second layer's index of refraction n₂ and extinction coefficient k₂, and also receives an initial value of thickness d₁ of the first layer and an initial value of thickness d₂ of the second layer. The user may input each parameter, or alternatively, a standard material parameter may previously be stored as a file or the like and read as necessary. Furthermore, if necessary, the ambient layer's index of refraction nₒ and extinction coefficient k₀ are also input.

The model expression indicating the theoretical reflectance is similar to reflectance R for object OBJ of the above described 3-layer system, and is a function at least including a value in thickness of each layer.

Furthermore, modeling unit 721 follows an instruction received from fitting unit 722 to update a parameter, as will be described hereinafter, to update the function indicating the theoretical reflectance, and follows the updated function to repeatedly calculate a theoretical reflectance (or spectrum) for each wavelength. More specifically, modeling unit 721 sequentially updates the first layer's thickness d₁ and the second layer's thickness d₂ as a parameter.

Fitting unit 722 reads a measured value of a reflectance spectrum from buffer unit 71, and calculates for each wavelength sequentially a square deviation of the measured value from a theoretical value of a reflectance spectrum output from modeling unit 721. Then, fitting unit 722 calculates a residual from the deviation for each wavelength, and determines whether this residual is equal to or smaller than a predetermined threshold value. In other words, fitting unit 722 determines whether the reflectance spectrum converges for the current parameter.

If the residual is larger than the predetermined threshold value, fitting unit 722 issues an instruction to modeling unit 721 to update the parameter, and awaits until a new theoretical value of the reflectance spectrum is output. In contrast, if the residual is equal to or smaller than the predetermined threshold value, fitting unit 722 outputs the first layer's current thickness d₁ and the second layer's current thickness d₂ as analyzed values.

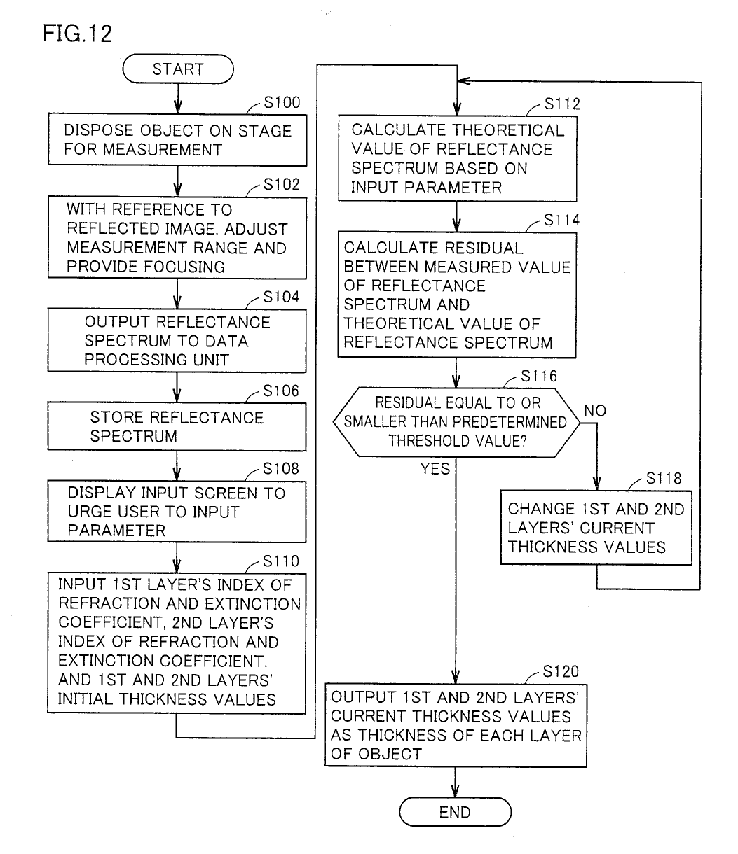

FIG. 12 is a flowchart of a procedure of the film thickness calculation process related to the processing pattern according to the first embodiment of the present invention.

With reference to FIG. 12, a user initially disposes an object (or sample) on a stage for measurement (Step S100). Then, the user inputs an instruction to prepare for measurement, and in response, a light source for observation starts emitting light for observation. The user refers to a reflected image obtained via an observation camera and displayed on a display unit, and accordingly issues an instruction to a movable mechanism for the stage's position to adjust a measurement range and provide focusing (Step S102).

After adjusting the measurement range and focusing are completed, the user issues an instruction to start measurement, and in response, measurement light source 10 (see FIG. 1) starts to generate measurement light. Spectrometry unit 40 receives light reflected from the object, and outputs a reflectance spectrum based on the reflected light to data processing unit 50 (Step S104). Then in data processing unit 50 CPU 200 temporarily stores to memory unit 212 or the like the reflectance spectrum detected in spectrometry unit 40 (Step S106). Thereafter in data processing unit 50 CPU 200 performs the film thickness calculation process described hereinafter. CPU 200 causes display unit 204 (see FIG. 10) or the like to display an input screen to urge the user to input a parameter (Step S108). Via the displayed input screen or the like, the user inputs index of refraction n₁ and extinction coefficient k₁ of the first layer of the object and index of refraction n₂ and extinction coefficient k₂ of the second layer of the object and also inputs an initial value of thickness d₁ of the first layer of the object and that of thickness d₂ of the second layer of the object (Step S110).

CPU 200 uses the parameter input by the user to calculate a theoretical value of the reflectance spectrum (Step S112). Then, CPU 200 calculates for each wavelength sequentially a square deviation between a measured value of the reflectance spectrum stored in memory unit 212 or the like and the theoretical value of the reflectance spectrum, and calculates a residual therebetween (Step S114). Furthermore, CPU 200 determines whether the calculated residual is equal to or smaller than a predetermined threshold value (Step S116).

If not (NO in step S116), CPU 200 modifies the current value of thickness d₁ of the first layer and that of thickness d₂ of the second layer (Step S118). Note that in which direction and to what extent thicknesses d₁ and d₂ are modified is determined depending on how often a residual arises. Then the control returns to Step S112.

If the calculated residual is equal to or smaller than the predetermined threshold value (YES in step S116), CPU 200 outputs the current value of thickness dᵢ of the first layer and that of thickness d₂ of the second layer as the thickness (or analyzed value) of each layer of the object (Step S120). The process thus ends.

Note that while in the FIG. 11 block diagram, indices of refraction n₁ and n₂ and extinction coefficients k₁ and k₂ having fixed values, respectively are input, an index of refraction and an extinction coefficient with wavelength dispersion considered may be used. For example, an index of refraction and an extinction coefficient with wavelength dispersion considered may be an expression of the Cauchy model as indicated below:

$$n ( λ ) = \frac{a}{{λ}^{4}} + \frac{b}{{λ}^{2}} + c$$

$$k ( λ ) = \frac{d}{{λ}^{4}} + \frac{e}{{λ}^{2}} + f$$

where a, b, c, d, e and f each represent a coefficient depending on a layer.

If such an expression is used, then an initial value or a known value is also previously input for each coefficient in the expression, and these coefficients are also subject to fitting.

Alternatively, an expression of the Sellmeier model as indicated below may be used:

$$n ( λ ) = \sqrt{f + \frac{g {λ}^{2}}{{λ}^{2} - h}}$$

where f, g and h each represent a Sellmeier coefficient and λ represents wavelength.

Exemplary Film Thickness Measurement

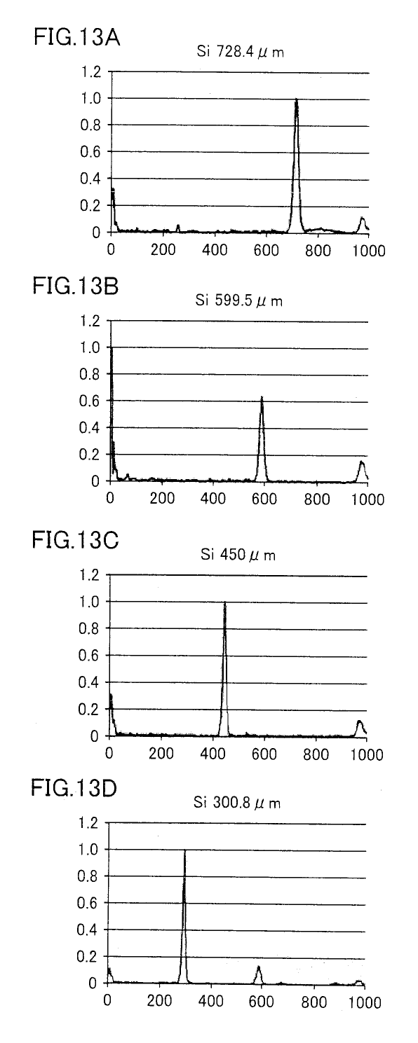

The present invention in the first embodiment allows film thickness measurement apparatus 100 to measure film in thickness, by way of example, as will be described hereinafter. FIG. 13A to FIG. 13D plot by way of example power spectra obtained by film thickness measurement apparatus 100 according to the first embodiment of the present invention. FIG. 13A to FIG. 13D represent power spectra as an example of measuring a Si layer of an object in thickness with film thickness measurement apparatus 100 and as a result of measurement for a period of time of 5 m seconds with WD1 of 5 mm with the object exposed to light having a spot diameter of about 9 μm. FIG. 13A represents a power spectrum obtained by measuring a Si layer of 728.4 μm in thickness, FIG. 13B represents a power spectrum obtained by measuring a Si layer of 599.5 μm in thickness, FIG. 13C represents a power spectrum obtained by measuring a Si layer of 450.0 μm in thickness, and FIG. 13D represents a power spectrum obtained by measuring a Si layer of 300.8 μm in thickness. FIG. 13A to FIG. 13D each have an axis of abscissa representing film in thickness (in μm) and an axis of ordinate representing spectral intensity. The FIGS. 13A-13D spectra each have a peak having a value, which is that of a Si layer measured with film thickness measurement apparatus 100.

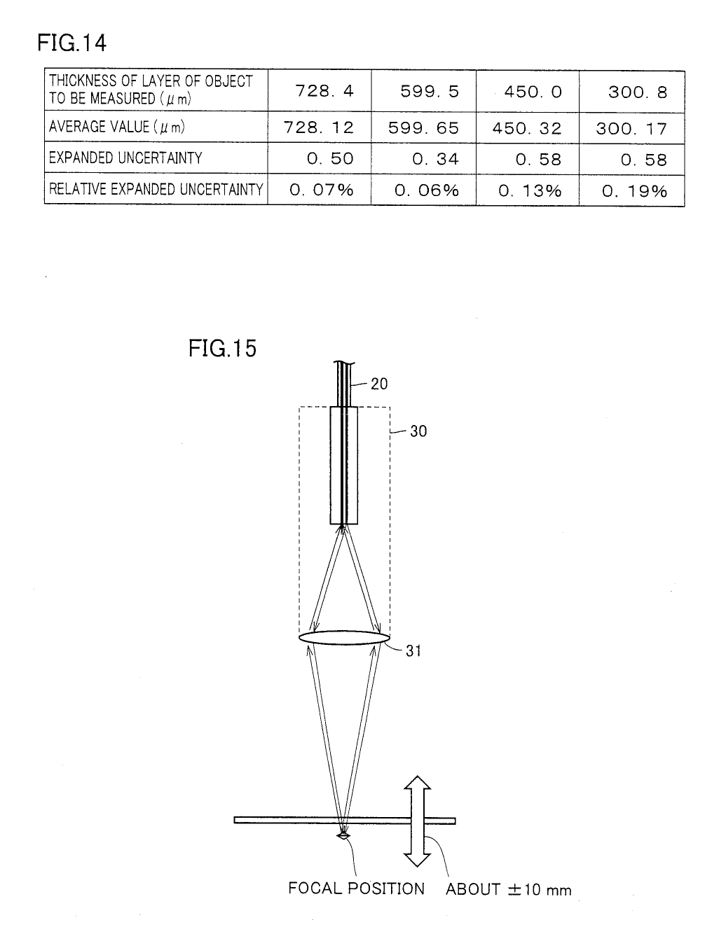

The Si layers having thicknesses indicated in FIG. 13A to FIG. 13D are measured with film thickness measurement apparatus 100 repeatedly 15 times. A result thereof is indicated as follows: FIG. 14 is a table showing an example of a result of measurement obtained by film thickness measurement apparatus 100 according to the first embodiment of the present invention. As shown in the FIG. 14 table, when the Si layers having the thicknesses indicated in FIG. 13A to FIG. 13D are measured with film thickness measurement apparatus 100 repeatedly 15 times, the layers each provide an average value, expanded uncertainty (standard deviation STD×2.1), and relative expanded uncertainty.

Specifically, when the Si layer of 728.4 μm in thickness (see FIG. 13A) is measured with film thickness measurement apparatus 100 repeatedly 15 times, the layer provides an average value of 728.12 μm, extended uncertainty of 0.50 μm, and relative extended uncertainty of 0.07%. When the Si layer of 599.5 μm in thickness (see FIG. 13B) is measured with film thickness measurement apparatus 100 repeatedly 15 times, the layer provides an average value of 599.65 μm, extended uncertainty of 0.34 μm, and relative extended uncertainty of 0.06%.

When the Si layer of 450.0 μm in thickness (see FIG. 13C) is measured with film thickness measurement apparatus 100 repeatedly 15 times, the layer provides an average value of 450.32 μm, extended uncertainty of 0.58 μm, and relative extended uncertainty of 0.13%. When the Si layer of 300.8 μm in thickness (see FIG. 13D) is measured with film thickness measurement apparatus 100 repeatedly 15 times, the layer provides an average value of 300.17 μm, extended uncertainty of 0.58 μm, and relative extended uncertainty of 0.19%.

From the above measurement result, it can be seen that film thickness measurement apparatus 100 can measure Si layer in thickness repeatably with high precision.

Stability of Film Thickness Measurement

Film thickness measurement apparatus 100 that includes condensing optical probe 30 can more reliably measure film in thickness, as will be described hereinafter. More specifically, it can provide steady measurement while the focal position varies and/or the object to be measured is inclined.

FIG. 15 is a schematic diagram for illustrating varying a focal position of condensing optical probe 30 in film thickness measurement apparatus 100 according to the first embodiment of the present invention. FIG. 15 shows condensing optical probe 30 such that adjustment mechanism 32 moves condenser lens 31 along the z axis to provide a focal position varying in a range of about ±10 mm. Note that film thickness measurement apparatus 100 measures a Si layer for a period of time of 10 m seconds with WD1 of 150 mm, with a spot of light having a diameter of about 27 μm at the focal position.

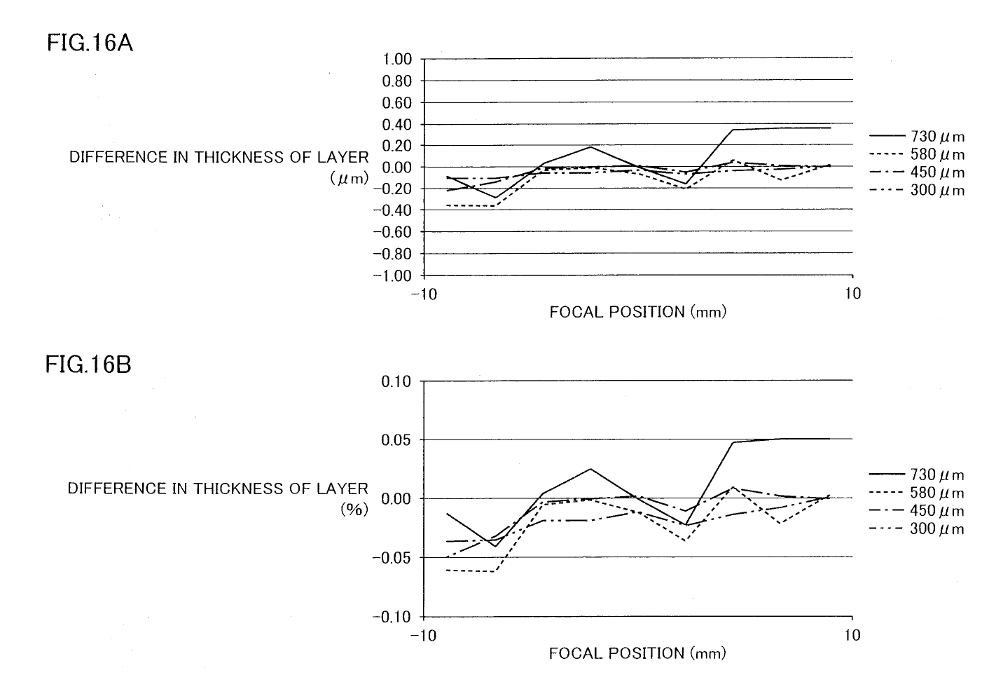

FIG. 16A and FIG. 16B show an example of a result of measurement obtained by film thickness measurement apparatus 100 according to the first embodiment of the present invention when it has a focal position changed. FIG. 16A and FIG. 16B show measurement results provided when Si layers of 728.4 μm, 599.5 μm, 450.0 μm and 300.8 μm in thickness are measured repeatedly 15 times with a focal position varied in a range of about ±10 mm.

FIG. 16A shows a measurement result indicating difference in thickness (in μm) depending on focal position, and is a graph plotted with an axis of abscissa representing focal position (in mm) and an axis of ordinate representing difference in thickness (in μm). As can be seen from FIG. 16A, when film thickness measurement apparatus 100 has a focal position varied in a range of about ±10 mm it measures the layers in thickness with a difference (in μm) within about ±0.40 μm.

FIG. 16B shows a measurement result indicating difference in thickness (in %) depending on focal position, and is a graph plotted with an axis of abscissa representing focal position (in mm) and an axis of ordinate representing difference in thickness (in %). As can be seen from FIG. 16B, when film thickness measurement apparatus 100 has a focal position varied in a range of about ±10 mm it measures the layers in thickness with a difference (in %) within about ±0.10%.

As described above, when film thickness measurement apparatus 100 has a focal position varied in a range of about ±10 mm, it can measure film in thickness with a difference (in μm) within about ±0.40 μm and a difference (in %) within about ±0.10%, and can thus reliably measure it while the focal position varies.

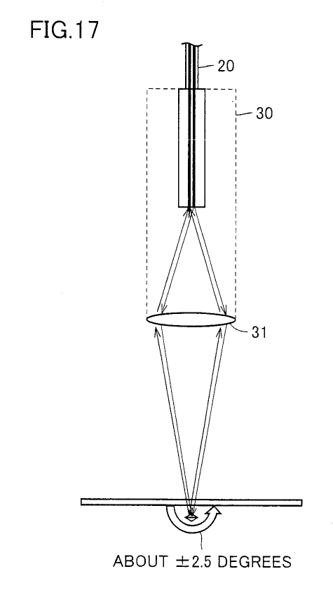

FIG. 17 is a schematic diagram for illustrating film thickness measurement apparatus 100 according to the first embodiment of the present invention measuring an inclined object. As shown in FIG. 17, condensing optical probe 30 or/and the object is/are moved to incline condensing optical probe 30 relative to the object in a range of about ±2.5 degrees. Note that film thickness measurement apparatus 100 measures a Si layer for a period of time of 10 m seconds with WD1 of 150 mm, with a spot of light having a diameter of about 27 μm at the focal position.

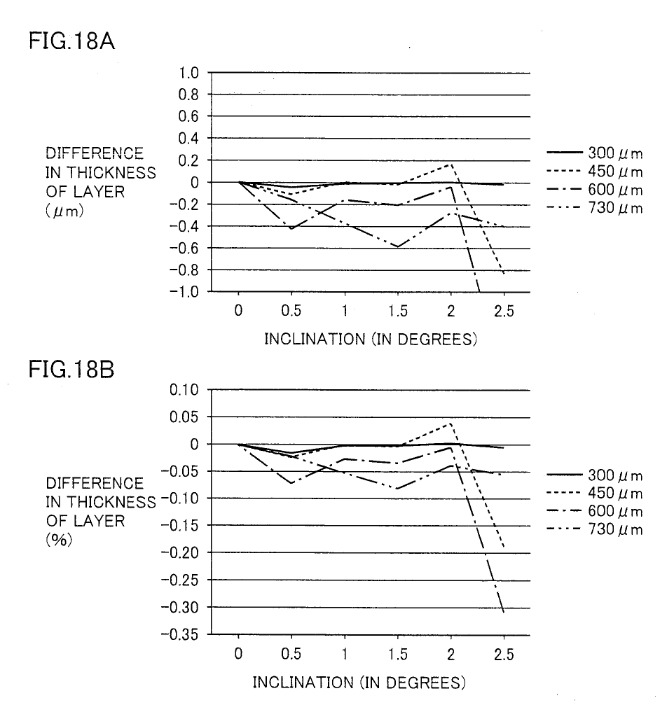

FIG. 18A and FIG. 18B show an example of a result of measurement obtained by film thickness measurement apparatus 100 according to the first embodiment of the present invention measuring an object varied in inclination. FIG. 18A and FIG. 18B show measurement results provided when Si layers of 728.4 μm, 599.5 μm, 450.0 μm and 300.8 μm in thickness are measured repeatedly 15 times with the object varied in inclination in a range of about ±2.5 degrees.

FIG. 18A shows a measurement result indicating difference in thickness (in μm) depending the object's inclination, and is a graph plotted with an axis of abscissa representing the object's inclination (in degrees) and an axis of ordinate representing difference in thickness (in μm). As can be seen from FIG. 18A, film thickness measurement apparatus 100 with the object inclined in a range of about ±2.5 degrees measures the layers in thickness with a difference (in μm) in a range from about +0.2 μm to about −1.00 μm. In particular, film thickness measurement apparatus 100 with the object inclined in a range of about ±2.0 degrees measures the layers in thickness with a difference (in μm) in a range from about +0.2 μm to about −0.6 μm.

FIG. 18B shows a measurement result indicating difference in thickness (in %) depending on the focal position, and is a graph plotted with an axis of abscissa representing the object's inclination (in degrees) and an axis of ordinate representing difference in thickness (in %). As can be seen from FIG. 18B, film thickness measurement apparatus 100 with the object inclined in a range of about ±2.5 degrees measures the layers in thickness with a difference (in %) in a range from about +0.05% to about −0.35%. In particular, film thickness measurement apparatus 100 with the object inclined in a range of about ±2.0 degrees measures the layers in thickness with a difference (in %) in a range from about +0.05% to about −0.1%.

As described above, film thickness measurement apparatus 100 with an object to be measured inclined in a range of about ±2.5 degrees can measure film in thickness with a difference (in μm) within a range from about +0.2 μm to about −1.00 μm and a difference (in %) in a range from about +0.05% to about −0.35%, and can thus reliably measure it while the object varies in inclination.

Example of Measurement Through Urethane

The present invention in the first embodiment provides film thickness measurement apparatus 100 that includes condensing optical probe 30, which allows measurement light to be focused at a film of an object to be measured, and if the object has the film under urethane or the like, film thickness measurement apparatus 100 can measure the film in thickness.

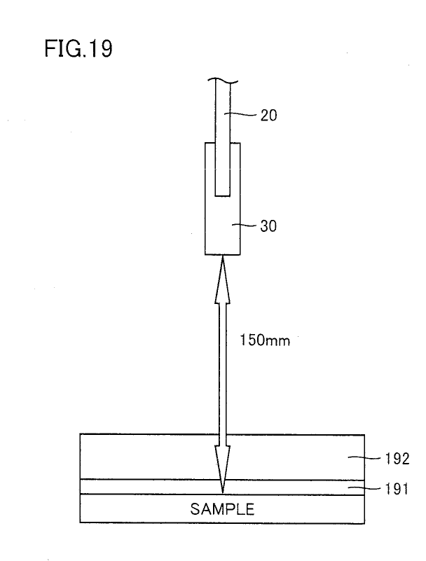

FIG. 19 is a schematic diagram showing an example of film thickness measurement apparatus 100 according to the first embodiment of the present invention measuring an object through urethane. FIG. 19 shows condensing optical probe 30 fixed at a position of 150 mm from the object, exposing the object to measurement light through a water screen 191 and urethane 192, and receiving light reflected by the object.

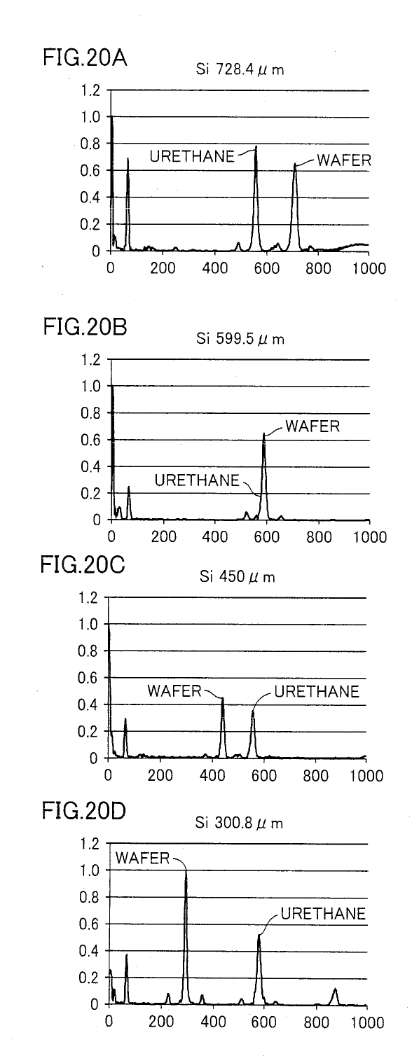

FIG. 20A to FIG. 20D plot by way of example power spectra measured with film thickness measurement apparatus 100 through water screen 191 and urethane 192 and thus obtained according to the first embodiment of the present invention. FIG. 20A to FIG. 20D each represent a power spectrum as an example of measuring a Si layer of an object in thickness with film thickness measurement apparatus 100 through water screen 191 and urethane 192. FIG. 20A represents a power spectrum obtained by measuring a Si layer of 728.4 μm in thickness, FIG. 20B represents a power spectrum obtained by measuring a Si layer of 599.5 μm in thickness, FIG. 20C represents a power spectrum obtained by measuring a Si layer of 450.0 μm in thickness, and FIG. 20D represents a power spectrum obtained by measuring a Si layer of 300.8 μm in thickness. FIG. 20A to FIG. 20D each have an axis of abscissa representing film in thickness (in μm) and an axis of ordinate representing spectral intensity. The FIGS. 20A-20D spectra each have a peak having a value, which is that of a Si layer measured with film thickness measurement apparatus 100. Note that a spectral peak around a thickness of 600 μm is a spectral peak attributed to urethane 192.

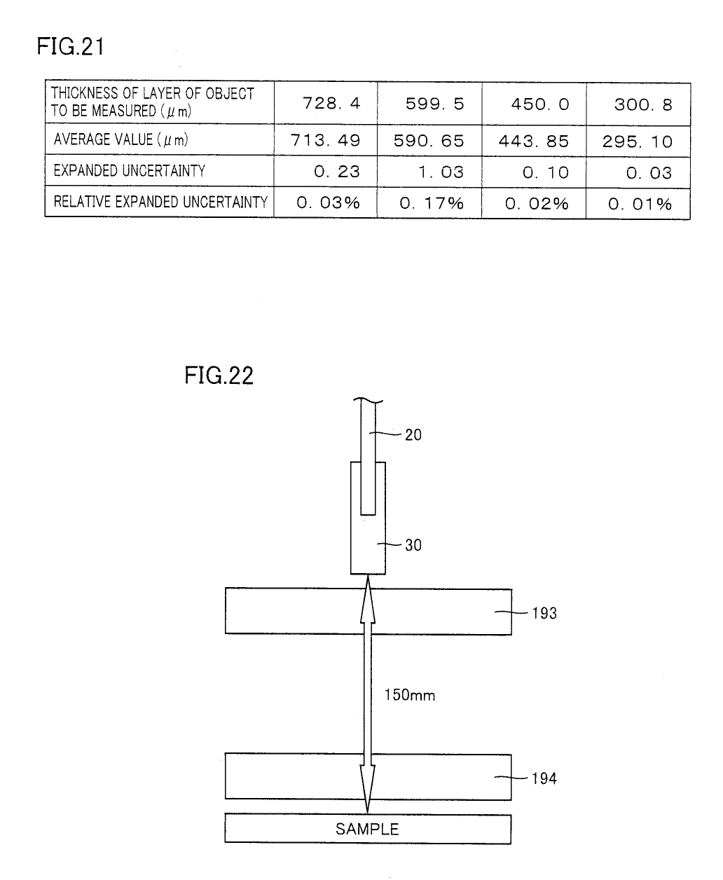

When the Si layers having thicknesses indicated in FIG. 20A to FIG. 20D are measured with film thickness measurement apparatus 100 repeatedly 15 times, the layers provide a result as follows: FIG. 21 is a table showing an example of a result of measurement obtained by film thickness measurement apparatus 100 according to the first embodiment of the present invention through water screen 191 and urethane 192. As shown in the FIG. 21 table, when the Si layers having the thicknesses indicated in FIG. 20A to FIG. 20D are measured with film thickness measurement apparatus 100 repeatedly 15 times, the layers each provide an average value, expanded uncertainty (standard deviation STD×2.1), and relative expanded uncertainty.

Specifically, when the Si layer of 728.4 μm in thickness (see FIG. 20A) is measured with film thickness measurement apparatus 100 repeatedly 15 times, the layer provides an average value of 713.49 μm, extended uncertainty of 0.23 μm, and relative extended uncertainty of 0.03%. When the Si layer of 599.5 μm in thickness (see FIG. 20B) is measured with film thickness measurement apparatus 100 repeatedly 15 times, the layer provides an average value of 590.65 μm, extended uncertainty of 1.03 μm, and relative extended uncertainty of 0.17%.

When the Si layer of 450.0 μM in thickness (see FIG. 20C) is measured with film thickness measurement apparatus 100 repeatedly 15 times, the layer provides an average value of 443.85 μm, extended uncertainty of 0.10 μm, and relative extended uncertainty of 0.02%. When the Si layer of 300.8 μM in thickness (see FIG. 20D) is measured with film thickness measurement apparatus 100 repeatedly 15 times, the layer provides an average value of 295.10 μm, extended uncertainty of 0.03 μm, and relative extended uncertainty of 0.01%.

From the above measurement result, it can be seen that film thickness measurement apparatus 100 can also measure Si layer in thickness through water screen 191 and urethane 192 with good repeatability (with relative extended uncertainty equal to or smaller than ±0.2%) and with high precision.

Note that film thickness measurement apparatus 100 can measure a film of an object in thickness not only through water screen 191 and urethane 192 but also through glass, plastic, or the like. FIG. 22 is a schematic diagram showing an example of film thickness measurement apparatus 100 according to the first embodiment of the present invention measuring an object through glass. FIG. 22 shows condensing optical probe 30 fixed at a position of 150 mm from the object, exposing the object to measurement light through glass 193, and receiving light reflected by the object. Note that the object shown in FIG. 22 has a surface covered with plastic 194.

Film thickness measurement apparatus 100 can thus measure a film of an object in thickness through glass 193 and hence externally through a window of a vapor deposition chamber or the like for example.

Light Source

Film thickness measurement apparatus 100 has been described for a configuration using as a light source an ASE light source capable of exposing an object to incoherent light. However, as has been described above, film thickness measurement apparatus 100 is not limited to the ASE light source, and it may employ an SLD light source capable of exposing an object to coherent light. Note that as film thickness measurement apparatus 100 employs a measurement method of a spectral interference system, the SLD light source's coherence results in a pseudo interference other than a spectral interference that should be measured, often confirmed as the fiber is bent or at a portion connected to spectrometry unit 40 and/or the like.

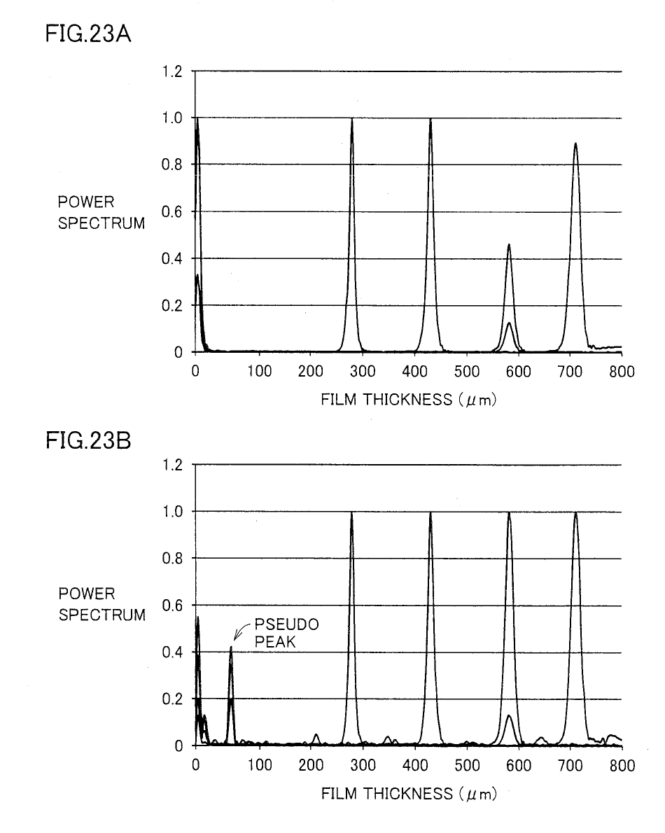

FIG. 23A and FIG. 23B plot by way of example power spectra measured with film thickness measurement apparatus 100 according to the first embodiment of the present invention with an ASE light source and an SLD light source used. FIG. 23A and FIG. 23B each have an axis of abscissa representing film in thickness (in μm) and an axis of ordinate representing spectral intensity.

FIG. 23A represents a power spectrum obtained by measuring a Si layer of an object in thickness with an ASE light source used. FIG. 23A represents spectral peaks corresponding to Si layers of 728.4 μm, 599.5 μm, 450.0 μm, and 300.8 μm in thickness.

FIG. 23B represents a power spectrum obtained by measuring a Si layer of an object in thickness with an SLD light source used. FIG. 23B represents spectral peaks corresponding to Si layers of 728.4 μm, 599.5 μm, 450.0 μm, and 300.8 μm in thickness. Furthermore, FIG. 23B represents a pseudo spectral peak around 70 μm in thickness. This pseudo peak is a spectral peak caused by the SLD light source's coherence, by bent fiber, at a portion connected to spectrometry unit 40, and/or the like, for a pseudo interference other than a spectral interference that should be measured.

Accordingly, to avoid the pseudo peak's effect, it is preferable that film thickness measurement apparatus 100 is used with the ASE light source.

The present invention in the first embodiment thus provides film thickness measurement apparatus 100 that is such a Y type fiber that optical fiber 20 having an optical path guiding measurement light that is emitted from measurement light source 10 to an object to be measured (or a first optical path) and optical fiber 20 having an optical path guiding light that is reflected by the object to spectrometry unit 40 (or a second optical path) have their respective optical axes that are closer to the object in parallel directions, respectively. Condenser lens 31 that condenses measurement light that is emitted from measurement light source 10 to the object and condenser lens 31 that condenses light reflected by the object are condensing optical probe 30 configured of a single lens. The present invention in the first embodiment can thus provide film thickness measurement apparatus 100 that can have condensing optical probe 30 reduced in size and can also measure a film of an object in thickness with high precision irrespective of its distance to the object.

### Second Embodiment

FIG. 1 shows condensing optical probe 30 such that a condenser lens that condenses measurement light that exits optical fiber 20 to an object to be measured and a condenser lens that condenses light that is reflected by the object at an end of optical fiber 20 are configured of a single condenser lens 31.

However, condensing optical probe 30 according to the present invention is not limited to this configuration, and a condenser lens that condenses measurement light that exits optical fiber 20 to the object and a condenser lens that condenses light that is reflected by the object at the end of optical fiber 20 may be discrete condenser lenses.

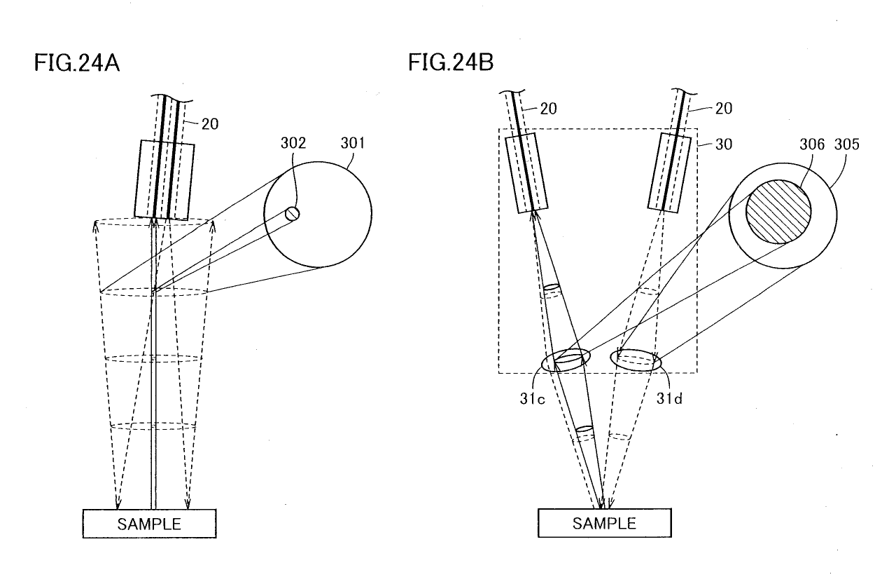

FIG. 24A and FIG. 24B are schematic diagrams for illustrating a configuration of condensing optical probe 30 according to a second embodiment of the present invention. The present invention in the second embodiment provides a film thickness measurement apparatus that is identical in configuration to the FIG. 1 film thickness measurement apparatus 100 except for optical fiber 20 and condensing optical probe 30 in configuration, and accordingly, identical components are identically denoted and will not be described repeatedly in detail.

FIG. 24A shows an object to be measured directly exposed to measurement light that exits optical fiber 20, rather than through condensing optical probe 30. Optical fiber 20 outputs light, which, as shown in FIG. 24A, is in turn spread by the angle of the aperture of optical fiber 20, and reflected by the object and further spread. In FIG. 24A, the object reflects light having range 301, of which optical fiber 20 can only receive reduced range of light 302.

FIG. 24B shows condensing optical probe 30 provided to condense measurement light from optical fiber 20 to expose thereto an object to be measured. Herein, optical fiber 20 is not a Y type fiber; rather, it is two single-mode fibers disposed to have their respective optical axes that are closer to the object mutually transversely. The light that exits one optical fiber 20 can be prevented by condenser lens 31c from spreading, as shown in FIG. 24B. The light condensed by condenser lens 31d is reflected by the object and will be spread again, however, it is condensed at an end of optical fiber 20 via condenser lens 31d.

Thus in FIG. 24B the object is exposed to light having a range 305 and reflects it, of which optical fiber 20 can receive increased range of light 306. Film thickness measurement apparatus 100 that includes two condenser lenses 31c and 31d can thus efficiently receive light reflected by the object. This provides an improved S/N ratio and thus allows spectrometry unit 40 to provide measurement with increased precision.

Furthermore, optical fiber 20 has two single-mode fibers disposed to have their respective optical axes that are closer to the object mutually transversely, and accordingly, an adjustment mechanism for condenser lenses 31c and 31d is only required to be movable along the z axis (or the optical axis), and may be immobile along the x and y axes (or in a direction perpendicular to the optical axis). Furthermore, the adjustment mechanism for condenser lenses 31c and 31d can adjust condenser lenses 31c and 31d independently and thus adjust measurement light that exits optical fiber 20 and light that is reflected by the object independently individually

Note, however, that condensing optical probe 30 according to the second embodiment of the present invention is equipped with two condenser lenses 31c and 31d, and thus larger in size than condensing optical probe 30 shown in FIG. 1.

The present invention in the second embodiment thus provides film thickness measurement apparatus 100 that has condenser lens 31c that condenses measurement light that exits optical fiber 20 (or a first optical path: an optical path that guides measurement light that is emitted from measurement light source 10 to an object to be measured) at the object, and condenser lens 31d that condenses light that is reflected by the object at an end of optical fiber 20 (or a second optical path: an optical path that guides the light that is reflected by the object to spectrometry unit 40). The present invention in the second embodiment can thus provide film thickness measurement apparatus 100 that can measure a film of an object in thickness with higher precision irrespective of its distance to the object.

### Third Embodiment

FIG. 1 shows condensing optical probe 30 including one optical fiber 20 that outputs measurement light to an object to be measured and another optical fiber 20 that receives light reflected by the object.

However, condensing optical probe 30 according to the present invention is not limited to this configuration, and for example it may include a plurality of optical fibers 20 to output measurement light to the object and a single optical fiber 20 to receive light reflected by the object.

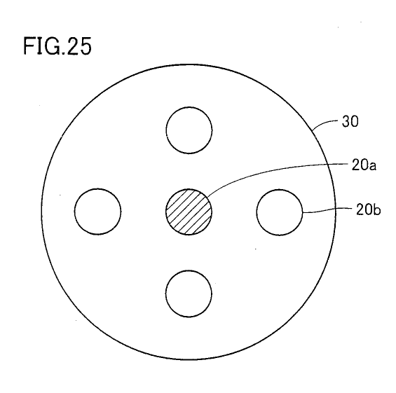

FIG. 25 is a schematic diagram for illustrating a configuration of condensing optical probe 30 according to a third embodiment of the present invention. The present invention in the third embodiment provides a film thickness measurement apparatus that is identical in configuration to the FIG. 1 film thickness measurement apparatus 100 except for optical fiber 20 and condensing optical probe 30 in configuration, and accordingly, identical components are identically denoted and will not be described repeatedly in detail.

FIG. 25 shows one surface of condensing optical probe 30 opposite to an object to be measured. The FIG. 25 condensing optical probe 30 has one optical fiber 20a provided at a center and receiving light reflected by the object, and four surrounding optical fibers 20b outputting measurement light to the object.

Optical fiber 20 outputs light, which, as shown in FIG. 3B, is in turn condensed by condenser lens 31 and the object is exposed thereto and reflects it, which is again condensed by condenser lens 31 and received by optical fiber 20. Film thickness measurement apparatus 100 exposes the object to light of range 303, and light of range 304 thereof that can be received by optical fiber 20 can be increased by adjusting the object's inclination, the position of condenser lens 31, and the like.

However, the object's inclination, the position of condenser lens 31, and the like can adjust only a limited range. Accordingly, the present invention in the third embodiment provides condensing optical probe 30 such that optical fibers 20b outputting measurement light to the object surround optical fiber 20a receiving light that is reflected by the object so that measurement light output from any one optical fiber 20b is received by optical fiber 20a.

That is, the object's inclination, the position of condenser lens 31, and the like are adjusted, and despite that when measurement light output from one optical fiber 20b cannot be successfully received by optical fiber 20a, measurement light output from another optical fiber 20b can be successfully received by optical fiber 20a.

The present invention in the third embodiment thus provides condensing optical probe 30 such that optical fiber 20 at a side thereof closer to an object to be measured has optical fiber 20a and a plurality of surrounding optical fibers 20b so that measurement light emitted from a light source to expose the object thereto can be received by optical fiber 20a efficiently.

While the FIG. 25 condensing optical probe 30 has one optical fiber 20a provided at a center and receiving light reflected by an object to be measured and four surrounding optical fibers 20b outputting measurement light to the object, condensing optical probe 30 according to the present invention is not limited thereto. For example, condensing optical probe 30 may have two optical fibers 20a provided at a center and receiving light reflected by the object, and 8 surrounding optical fibers 20b outputting measurement light to the object. Furthermore, condensing optical probe 30 may have one optical fiber 20b provided at a center and outputting measurement light to the object, and 4 surrounding optical fibers 20a receiving light reflected by the object. Although the present invention has been described and illustrated in detail, it is clearly understood that the same is by way of illustration and example only and is not to be taken by way of limitation, the scope of the present invention being interpreted by the terms of the appended claims.

What is claimed is:

1. A film thickness measurement apparatus comprising:
a light source that exposes an object to be measured to measurement light having a predetermined wavelength range, said object including a substrate and at least one layer of film on said substrate;
at least one first optical path that guides to said object said measurement light emitted from said light source;
a first condenser lens that condenses said measurement light that exits via said first optical path at said object;
a spectrometry unit that obtains a wavelength distribution characteristic of one of reflectance and transmittance based on said measurement light condensed by said first condenser lens that is one of light reflected by said object and light transmitted through said object;
at least one second optical path that guides one of the light reflected by said object and the light transmitted through said object to said spectrometry unit;
a second condenser lens that condenses one of the light reflected by said object and the light transmitted through said object at an end of said second optical path; and
a data processing unit that analyzes said wavelength distribution characteristic obtained in said spectrometry unit to obtain a film thickness of said object.

2. The film thickness measurement apparatus according to claim 1, wherein said first optical path and said second optical path are single-mode fiber.

3. The film thickness measurement apparatus according to claim 1, wherein:
said first optical path and said second optical path are Y type fiber having their respective optical axes that are closer to said object in parallel directions, respectively; and
said first condenser lens and said second condenser lens are a condensing optical probe configured of a single lens.

4. The film thickness measurement apparatus according to claim 3, wherein said Y type fiber at a side thereof closer to said object has more than one said first optical path around said second optical path.

5. The film thickness measurement apparatus according to claim 1, wherein said light source emits incoherent light as said measurement light.

6. The film thickness measurement apparatus according to claim 1, wherein said spectrometry unit can obtain said wavelength distribution characteristic of one of reflectance and transmittance in a range in wavelength of an infrared range.
